(19) United States
(12) Patent Application Publication
(10) Pub. No.: US 2026/0265572 A1
(43) Pub. Date: Sep. 10, 2026

(54) SURFACE-TREATED STEEL SHEET

(71) Applicant: NIPPON STEEL CORPORATION, Chiyoda-ku, Tokyo (JP)

(72) Inventors: Takashi FUJII, Tokyo (JP); Yasuaki KAWAMURA, Tokyo (JP); Kunihiko TOSHIN, Tokyo (JP); Akira NAKAGAWA, Tokyo (JP)

(73) Assignee: NIPPON STEEL CORPORATION, Chiyoda-ku, Tokyo (JP)

(21) Appl. No.: 19/167,046

(22) PCT Filed: Mar. 29, 2024
(86) PCT No.: PCT/JP2024/013186

§ 371 Date: Sep. 19, 2025

(30) Foreign Application Priority Data
Mar. 30, 2023 (JP) 2023-055376

(51) Int. Cl. C09D 163/00; C09D 7/40; C09D 7/61; C09D 175/04; C25D 3/56

(52) U.S. Cl. CPC C09D 163/00; C09D 7/61; C09D 7/67; C09D 7/68; C09D 175/04; C25D 3/562; C25D 3/565

(57) ABSTRACT

A surface-treated steel sheet includes a plating layer containing zinc and nickel; a first composite layer located between the steel sheet and the plating layer and containing Fe, Zn, and Ni; a chromium-containing composite layer located on the plating layer and containing at least Cr; and a paint film located on the chromium-containing composite layer and containing an epoxy resin, an isocyanate resin, and a silica particle. An amount of the plating layer is 2 to 50 g/m² per single side. The chromium-containing composite layer includes a second composite layer located on the plating layer side and containing Cr, Zn, and Ni, and a third composite layer located on the paint film side and containing Si, N, and Cr. An amount of the chromium-containing composite layer is 10 to 200 mg/m² in terms of metal Cr. A thickness of the paint film is 0.5 to 2.0 μm.

### TECHNICAL FIELD

The present invention relates to a surface-treated steel sheet.

### BACKGROUND ART

As a raw material when manufacturing a fuel tank of a motorcycle, various plated steel sheets are used. When manufacturing the fuel tank, the plated steel sheet being the raw material needs to be processed into a desired shape. Further, the surface of the plated steel sheet on the side exposed to the fuel such as gasoline is required to have corrosion resistance for preventing corrosion due to the fuel. Therefore, the plated steel sheet used as the raw material for the fuel tank has been required to achieve both formability and corrosion resistance.

To achieve both the formability and the corrosion resistance, for example, Patent Document 1 below discloses an organic composite plated steel sheet in which a chromate film and a film composed of a paint composition are formed on the surface of a zinc, aluminum, or zinc-based alloy plated steel sheet.

### PRIOR ART DOCUMENT

### Patent Document

Patent Document 1: Japanese Examined Patent Publication No. H4-28539

### SUMMARY OF THE INVENTION

### Problems to be Solved by the Invention

Here, the present inventors further studied the organic composite plated steel sheet disclosed in Patent Document 1 above to find that there is room to further improve the achievement of both the adhesion and the corrosion resistance of a film after molding processing.

Hence, the present invention has been made in light of the above viewpoint, and an object of the present invention is to provide a surface-treated steel sheet in which the adhesion and the corrosion resistance of a film after molding processing can be further improved.

### Means for Solving the Problems

The present inventors intensively studied to solve the above problem to have conceived that both the adhesion and the corrosion resistance of a film after molding processing can be further improved by appropriately forming a specific composite layer in a stacked structure realized by a surface-treated steel sheet.

The gist of the present invention completed based on the findings is as follows.
(1) A surface-treated steel sheet including: a plating layer located on at least one surface of a steel sheet and containing zinc and nickel; a first composite layer located between the steel sheet and the plating layer and containing Fe, Zn, and Ni; a chromium-containing composite layer located on the plating layer and containing at least Cr; and a paint film located on the chromium-containing composite layer and containing an epoxy resin, an isocyanate resin, and a silica particle, wherein: an amount of the plating layer is 2 to 50 g/m² per single side; the chromium-containing composite layer includes a second composite layer located on the plating layer side and containing Cr, Zn, and Ni, and a third composite layer located on the paint film side and containing Si, N, and Cr; an amount of the chromium-containing composite layer is 10 to 200 mg/m² in terms of metal Cr; and a thickness of the paint film is 0.5 to 2.0 μm.
(2) The surface-treated steel sheet according to (1), wherein: a ratio (d2/d1) of an average thickness d2 of the second composite layer to an average thickness d1 of the first composite layer is 0.2 to 150.0; and a ratio (d3/d1) of an average thickness d3 of the third composite layer to the average thickness d1 of the first composite layer is 0.2 to 150.0.
(3) The surface-treated steel sheet according to (1) or (2), wherein: the paint film contains a polyethylene wax at a ratio of 0.1 to 10.0 mass % based on a non-volatile content of paint film; a content of the epoxy resin is 30.0 mass % or more based on the non-volatile content of paint film; a content of the isocyanate resin is 0.10 to 2.00 by mass ratio with respect to the epoxy resin; a content of the silica particle is 5.0 to 50.0 mass % based on the non-volatile content of paint film; and the paint film contains the epoxy resin, the isocyanate resin, the silica particle, and the polyethylene wax in a total of 100 mass % or less.
(4) The surface-treated steel sheet according to (1) or (2), wherein the epoxy resin is a bisphenol A-type epoxy resin having a number average molecular weight of 300 to 100000.
(5) The surface-treated steel sheet according to (1) or (2), wherein: the silica particle is at least any of fumed silica and colloidal silica; an average particle diameter of the fumed silica is 5 to 40 nm; and an average particle diameter of the colloidal silica is 5 to 200 nm.
6) The surface-treated steel sheet according to (1) or (2), which is used as a raw material for a fuel tank.

### Effect of the Invention

As explained above, according to the present invention, it is possible to further improve the adhesion and the corrosion resistance of a film after molding processing in a surface-treated steel sheet.

### BRIEF DESCRIPTION OF THE DRAWINGS

FIG. 1 is an explanatory view schematically illustrating the structure of a surface-treated steel sheet according to an embodiment of the present invention.

FIG. 2 is an explanatory view for explaining a first composite layer in the surface-treated steel sheet according to the embodiment.

FIG. 3 is an explanatory view for explaining the first composite layer in the surface-treated steel sheet according to the embodiment.

FIG. 4 is an explanatory view for explaining a chromium-containing composite layer in the surface-treated steel sheet according to the embodiment.

FIG. 5 is an explanatory view for explaining the chromium-containing composite layer in the surface-treated steel sheet according to the embodiment.

FIG. 6 is an explanatory view for explaining the chromium-containing composite layer in the surface-treated steel sheet according to the embodiment.

FIG. 7 is a flowchart illustrating an example of the flow of a method of manufacturing the surface-treated steel sheet according to the embodiment.

### EMBODIMENTS FOR CARRYING OUT THE INVENTION

Hereinafter, preferred embodiments of the present invention will be explained in detail with reference to the accompanying drawings. Note that 20 the same codes denote components having substantially the same functional configurations in this description and the drawings to omit duplicate explanations.

### <Regarding the Overall Configuration of a Surface-Treated Steel Sheet>

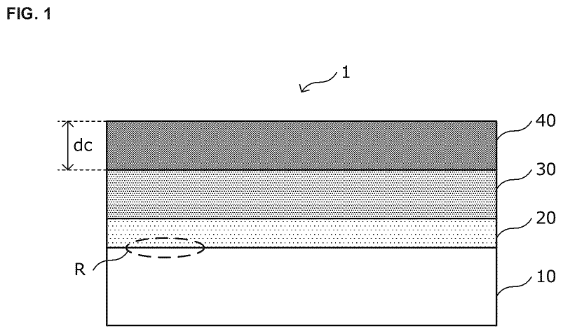

First, the overall configuration of a surface-treated steel sheet according to this embodiment will be explained with reference to FIG. 1. FIG. 1 is an explanatory view schematically illustrating the structure of the surface-treated steel sheet according to this embodiment.

As illustrated in FIG. 1, a surface-treated steel sheet 1 according to this embodiment has a steel sheet 10, a plating layer 20, a chromium-containing composite layer 30, and a paint film 40. The surface-treated steel sheet 1 can be preferably used as a raw material for fuel tanks of various automobiles (specifically, motorcycles).

Note that the case where the plating layer 20, the chromium-containing composite layer 30, and the paint film 40 are provided on one surface of the steel sheet 10 is illustrated in FIG. 1, but the plating layer 20, the chromium-containing composite layer 30, and the paint film 40 may be provided on both surfaces of the steel sheet 10.

### [Regarding the Steel Sheet 10]

The steel sheet 10 is a base metal of the surface-treated steel sheet 1 according to this embodiment, and various steel sheets can be used according to the strength or the like (for example, tensile strength or the like) required of the surface-treated steel sheet 1. Examples of the steel sheet include ordinary steel, low carbon steel, high-strength steel, and so on.

However, when manufacturing a fuel tank that is one of important uses of the surface-treated steel sheet 1 according to this embodiment, the steel sheet being a raw material is required to have high level of formability. Therefore, it is preferable to use IF steel excellent in formability as the steel sheet 10 according to this embodiment, and more preferable to use a steel sheet containing several ppm or more of boron (B) in order to ensure airtightness after welding, secondary formability, and so on.

Besides, the thickness of the steel sheet 10 only needs to be set appropriately according to the strength required of the surface-treated steel sheet 1, the mass permitted for an article to be manufactured by processing the surface-treated steel sheet 1, and so on.

### [Regarding the Plating Layer 20]

The plating layer 20 in the surface-treated steel sheet 1 is a layer provided to ensure the corrosion resistance of the steel sheet 10 being the base metal. The plating layer 20 according to this embodiment is a plating layer which is located on at least one surface of the steel sheet 10 and contains zinc (Zn) and nickel (Ni).

By providing the plating layer 20 containing zinc and nickel, the plating layer 20 exhibits excellent resistance weldability, formability, and corrosion resistance (specifically, gasoline resistance). It is preferable that an Ni content is within a range of 5 to 15 mass % with the balance of Zn and impurities in the plating layer 20.

By setting the Ni content to 5 mass % or more, it becomes possible to further improve the corrosion resistance without causing a decrease in resistance weldability and formability. The Ni content is more preferably 8 mass % or more. On the other hand, by setting the Ni content to 15 mass % or less, it becomes possible to further suppress the occurrence of large cracks in the plating layer 20 to further ensure the adhesion of the plating layer 20. The Ni content is more preferably 13 mass % or less.

The amount of the plating layer 20 is in a range of 2 to 50 g/m² per single side. By setting the amount of the plating layer 20 to 2 g/m² or more, it becomes possible to sufficiently develop the characteristics such as the resistance weldability, formability, corrosion resistance, and so on exhibited by the plating layer 20. The amount of the plating layer 20 is more preferably 5 g/m² or more. On the other hand, by setting the amount of the plating layer 20 to 50 g/m² or less, it becomes possible to achieve both the resistance weldability and formability, and the corrosion resistance, in a more preferable state. The amount of the plating layer 20 is more preferably 40 g/m² or less.

Note that the amount of the plating layer 20 can be calculated from a mass difference between before and after removal when the plating layer 20 whose area is known is physically or chemically removed from the top of the steel sheet 10. The method for removing the plating layer 20 from the steel sheet 10 is not particularly limited and is, for example, blasting as a physical method and a method such as an acid dissolution treatment as a chemical method. Further, the Ni content of the plating layer 20 can be identified by measuring the plating layer 20 removed from the top of the steel sheet 10 as above by a fluorescent X-ray analyzer.

### [Regarding the Chromium-Containing Composite Layer 30]

The chromium-containing composite layer 30 according to this embodiment is located on the plating layer 20, and is a composite layer containing at least chromium (Cr). The chromium-containing composite layer 30 is a layer which improves the adhesion between the above-explained plating layer 20 and the later-explained paint film 40 and contributes to the improvement in corrosion resistance as the surface-treated steel sheet 1.

The amount of the chromium-containing composite layer 30 is 10 to 200 mg/m² in terms of metal Cr. When the amount of the chromium-containing composite layer 30 is less than 10 mg/m², the amount of the chromium-containing composite layer 30 becomes too small, resulting in difficulty in developing the effect of improving the above adhesion. When the amount of the chromium-containing composite layer 30 is 10 mg/m² or more, the adhesion between the plating layer 20 and the later-explained paint film 40 can be improved. The amount of the chromium-containing composite layer 30 is preferably 20 mg/m² or more and more preferably 30 mg/m² or more.

On the other hand, when the amount of the chromium-containing composite layer 30 is more than 200 mg/m², the amount of the chromium-containing composite layer 30 becomes too large, possibly resulting in that the later-explained paint film 40 becomes likely to peel off. When the amount of the chromium-containing composite layer 30 is 200 mg/m² or less, the adhesion between the plating layer 20 and the later-explained paint film 40 can be stably improved. The amount of the chromium-containing composite layer 30 is preferably 150 mg/m² or less and more preferably 100 mg/m² or less.

Here, a layer satisfying the following conditions in the surface-treated steel sheet 1 according to this embodiment is assumed to be the chromium-containing composite layer 30. The chromium-containing composite layer 30 can be discriminated based on a depth profile of chromium when acquiring the depth profile regarding the distribution of elements from the surface of the later-explained paint film 40, for example, by an RF-Glow Discharge Optical Emission Spectroscopy (RF-GD-OES). Specifically, when a position where the intensity regarding the element chromium becomes maximum is a position of the peak intensity in the depth profile of chromium located between the paint film 40 and the plating layer 20, a position where the peak intensity of chromium reduces by half on the paint film 40 side can be defined as the position of the interface on the paint film 40 side of the chromium-containing composite layer 30, and a position where the peak intensity of chromium reduces by half on the plating layer 20 side can be defined as the position of the interface on the plating layer 20 side of the chromium-containing composite layer 30.

Note that the measurement by the above RF-GD-OES only needs to be performed until a spectrum of iron derived from underlying steel is detected as an intensity by using a Glow Discharge Optical Emission Spectroscopy (for example, Marcus-type high-frequency Glow Discharge Optical Emission Spectroscopy GD-Profiler 2 manufactured by HORIBA Jobin Yvon, Ltd.) under conditions of a gas replacement time of 30 seconds, a preliminary sputtering time of 30 seconds, a pressure of 600 Pa, and an output of 35 W.

Further, the amount of the chromium-containing composite layer 30 can be calculated from a calibration curve indicating the relation between the intensity of X-ray fluorescence regarding chromium and the amount, for example, by a quantitative analysis using the X-ray fluorescence. Further, the amount of the chromium-containing composite layer 30 can also be calculated by analyzing an aqueous solution in which the chromium-containing composite layer 30 is dissolved, by an inductively coupled plasma (ICP) optical emission spectrometry.

Here, in the case of identifying the amount of the chromium-containing composite layer 30 from the surface-treated steel sheet in a state of having already been processed into various parts such as the fuel tank, it is only necessary to cut out a test piece from a region which has not been subjected to bonding process such as various welding or processing such as drawing or bending in a part to be focused on, and to use it as an analysis object. In this event, the size of the test piece to be cut out only needs to be, for example, about 50× 50 mm in size when the test piece is made into a flat plate shape. The measurement by the above RF-GD-OES is performed using a part of the obtained test piece to identify a region of the test piece corresponding to the chromium-containing composite layer 30. Then, the fluorescent X-ray analysis or the ICP emission spectrochemical analysis only needs to be performed on the region corresponding to the chromium-containing composite layer 30 of the obtained test piece.

The detailed configuration of the chromium-containing composite layer 30 will be explained later again.

### [Regarding the Paint Film 40]

The paint film 40 according to this embodiment is located on the chromium-containing composite layer 30, and is a resin layer containing an epoxy resin, an isocyanate resin, and a silica particle. Further, the paint film 40 preferably contains a polyethylene wax in addition to the above components. By providing the paint film 40, the surface-treated steel sheet 1 according to this embodiment exhibits excellent corrosion resistance, formability, and electrodeposition paintability.

### <<Epoxy Resin>>

The epoxy resin contained in the paint film 40 according to this embodiment is a resin which functions as a binder resin. The paint film 40 containing the epoxy resin improves in water resistance and alkali resistance as a paint film and also improves in adhesion with respect to other layer structures. In the paint film 40 according to this embodiment, it is preferable to use, for example, a bisphenol A-type epoxy resin as the epoxy resin.

Besides, a number average molecular weight of the epoxy resin contained in the paint film 40 according to this embodiment is preferably in a range of 300 to 100000.

By setting the number average molecular weight of the epoxy resin to 300 or more, it becomes possible to sufficiently polymerize the resin by a cross-linking reaction to further improve the corrosion resistance of the paint film. The number average molecular weight of the epoxy resin is more preferably 1000 or more and furthermore preferably 2000 or more. On the other hand, by setting the number average molecular weight of the epoxy resin to 100000 or less, it becomes possible to sufficiently polymerize the resin by a cross-linking reaction to further improve the corrosion resistance of the paint film. The number average molecular weight of the epoxy resin is more preferably 20000 or less and furthermore preferably 10000 or less.

Further, it is furthermore preferable to use an epoxy resin having an epoxy equivalent in a range of 1000 to 3500 among epoxy resins having the number average molecular weight in the above range. By setting the epoxy equivalent of the epoxy resin to 1000 or more, it becomes possible to more appropriately crosslink the epoxy resin to improve the corrosion resistance of the paint film. The epoxy equivalent of the epoxy resin is more preferably 1500 or more and furthermore preferably 2000 or more. On the other hand, by setting the epoxy equivalent of the epoxy resin to 3500 or less, it becomes possible to suppress excessive polymerization of the epoxy resin to further improve the corrosion resistance of the paint film while maintaining the formability of the paint film 40. The epoxy equivalent of the epoxy resin is more preferably 3000 or less and furthermore preferably 2500 or less.

### <<Isocyanate Resin>>

The isocyanate resin contained in the paint film 40 according to this embodiment is a resin which functions as a curing agent and can appropriately cure the paint film 40 to develop excellent corrosion resistance, formability, and adhesion. Here, the isocyanate resin according to this embodiment means a resin having an isocyanate group or a low molecular compound having an isocyanate group, and examples of the isocyanate resin include a polyisocyanate compound, a blocked polyisocyanate compound, and so on. Examples of the polyisocyanate compound include an aliphatic or alicyclic diisocyanate compound, an aromatic diisocyanate compound, a triisocyanate compound, and so on.

Here, examples of the aliphatic or alicyclic diisocyanate compound include hexamethylene diisocyanate, isophorone diisocyanate, hydrogenated diphenylmethane diisocyanate, and so on. Examples of the aromatic diisocyanate compound include tolylene diisocyanate, diphenylmethane-4,4′-diisocyanate, and so on. Examples of the triisocyanate compound include an adduct body of 1 mol of trimethylolpropane and 3 mol of diisocyanate, a trimer of diisocyanate such as hexamethylene diisocyanate and tolylene diisocyanate.

Besides, the blocked polyisocyanate compound is made by blocking the polyisocyanate compound exemplified above with a blocking agent. A preferable blocking agent is the one in which an adduct generated by being added to the isocyanate group is stable at room temperature and which is dissociated at baking and forming the paint film to reproduce a free isocyanate group.

Examples of the blocking agent include a lactam-based blocking agent, an oxime-based blocking agent, an alcohol-based blocking agent, a phenol-based blocking agent, an ester-based blocking agent, and so on.

Here, examples of the lactam-based blocking agent include ε-caprolactam, γ-butyrolactam, and so on. Examples of the oxime-based blocking agent include methyl ethyl ketoxime, cyclohexanone oxime, and so on. Examples of the alcohol-based blocking agent include methanol, ethanol, isobutyl alcohol, and so on. Examples of the phenol-based blocking agent include phenol, p-tert-butylphenol, cresol, and so on. Examples of the ester-based blocking agent include ethyl acetoacetate, methyl acetoacetate, and so on. Note that among the above blocking agents, methyl ethyl ketoxime and ethyl acetoacetate are particularly preferable blocking agents from a viewpoint of dissociating at a low temperature and being stable in a state of storing the paint for forming a paint film.

In the paint film 40 according to this embodiment, the above polyisocyanate compound and blocked polyisocyanate compound can be used alone or two or more of them can be used in combination. Further, the above-exemplified compounds are merely examples of the isocyanate resin, and an isocyanate resin other than the above can also be used.

### <<Silica Particle>>

The silica particle contained in the paint film 40 according to this embodiment is a component contained in order to further improve the corrosion resistance of the paint film 40 while preventing the components in the paint film 40 from eluting to the outside of the paint film. Examples of the silica particle include fumed silica, colloidal silica, and so on. In the paint film 40 according to this embodiment, at least any of the silica particles is used.

Here, an average particle diameter of the fumed silica is preferably in a range of 5 to 40 nm. By setting the average particle diameter of the fumed silica to 5 nm or more, it becomes possible to further improve the corrosion resistance and the adhesion of the paint film 40. The average particle diameter of the fumed silica is more preferably 7 nm or more. On the other hand, by setting the average particle diameter of the fumed silica to 40 nm or less, it becomes possible to further improve the corrosion resistance while maintaining the smoothness of the paint film 40. The average particle diameter of the fumed silica is more preferably 16 nm or less.

Besides, an average particle diameter of the colloidal silica is preferably in a range of 5 to 200 nm. By setting the average particle diameter of the colloidal silica to 5 nm or more, it becomes possible to further improve the corrosion resistance and the adhesion of the paint film 40. The average particle diameter of the colloidal silica is more preferably 9 nm or more and furthermore preferably 12 nm or more. On the other hand, by setting the average particle diameter of the colloidal silica to 200 nm or less, it becomes possible to further improve the corrosion resistance while maintaining the smoothness of the paint film 40. The average particle diameter of the colloidal silica is more preferably 60 nm or less and further more preferably 22 nm or less.

### <<Polyethylene Wax>>

The polyethylene wax contained in the paint film 40 according to this embodiment is the one which functions as a lubricant and the one which further improves the formability of the surface-treated steel sheet 1 according to this embodiment. Specifically, as the polyethylene wax, it is preferable to use a polyethylene wax having a density of 0.94 or more, a molecular weight in a range of 1000 to 10000, and an acid value of 15 KOH mg/g or less. The use of the polyethylene wax having the above density, molecular weight, and acid value makes it possible to further improve the formability of the surface-treated steel sheet 1.

Further, in the paint film 40 according to this embodiment, various lubricants such as a polyolefin-based lubricant, a carboxylic acid ester-based lubricant, a carboxylic acid metal salt, a polyalkylene glycol-based lubricant, and so on, and various lubricant powders of a molybdenum disulfide, a silicone compound, a fluorine compound in addition to the above polyethylene wax.

### <<Contents of the Above Components>>

In the paint film 40 according to this embodiment, the contents of the above epoxy resin, isocyanate resin, silica particle, and polyethylene wax preferably satisfy the following conditions.

Specifically, the content of the epoxy resin is 30.0 mass % or more based on a non-volatile content of paint film (namely, based on the total mass of the paint film 40), the content of the isocyanate resin is 0.10 to 2.00 by mass ratio with respect to the epoxy resin, the content of the silica particle is 5.0 to 50.0 mass % based on the non-volatile content of paint film (namely, based on the total mass of the paint film 40), the content of the polyethylene wax is 0.1 to 10.0 mass % based on the non-volatile content of paint film (namely, based on the total mass of the paint film 40), and the epoxy resin, the isocyanate resin, the silica particle, and the polyethylene wax are preferably contained in a total of 100 mass % or less.

By setting the content of the epoxy resin to 30.0 mass % or more based on the total mass of the non-volatile content of paint film (namely, the paint film 40), it becomes possible to suppress embrittlement of the paint film 40 to further improve the forming adhesion of the paint film 40. The content of the epoxy resin is more preferably 45.0 mass % or more and furthermore preferably 50.0 mass % or more based on the non-volatile content of paint film.

By setting the content of the isocyanate resin to 0.10 or more by mass ratio with respect to the epoxy resin, it becomes possible to bring the epoxy resin and the isocyanate resin into a preferable crosslinked state to thereby realize the paint film excellent in corrosion resistance. The content of the isocyanate resin is more preferably 0.15 or more and furthermore preferably 0.20 or more by mass ratio with respect to the epoxy resin. On the other hand, by setting the content of the isocyanate resin to 2.00 or less by mass ratio with respect to the epoxy resin, it becomes possible to further improve the adhesion of the paint film 40 while maintaining the water resistance and the alkaline resistance of the paint film 40. The content of the isocyanate resin is more preferably 0.90 or less and furthermore preferably 0.50 or less by mass ratio with respect to the epoxy resin.

By setting the content of the silica particle to 5.0 mass % or more based on the total mass of the non-volatile content of paint film (namely, the paint film 40), it becomes possible to further improve the corrosion resistance of the paint film 40. The content of the silica particle is more preferably 18.0 mass % or more and furthermore preferably 23.0 mass % or more based on the non-volatile content of paint film. On the other hand, by setting the content of the silica particle to 50.0 mass % or less based on the total mass of the non-volatile content of paint film, it becomes possible to prevent a decrease in forming adhesion of the paint film 40. The content of the silica particle is more preferably 38.0 mass % or less and furthermore preferably 33.0 mass % or less based on the non-volatile content of paint film.

By setting the content of the polyethylene wax to 0.1 mass % or more based on the total mass of the non-volatile content of paint film (namely, the paint film 40), it becomes possible to decrease the frictional resistance of the surface of the paint film 40 to prevent the paint film peeling during processing. The content of the polyethylene wax is more preferably 1.0 mass % or more and furthermore preferably 1.5 mass % or more based on the non-volatile content of paint film. On the other hand, by setting the content of the polyethylene wax to 10.0 mass % or less based on the total mass of the non-volatile content of paint film, it becomes possible to prevent the occurrence of shrinkage unevenness pattern or the like of the polyethylene wax to realize the paint film 40 excellent in external appearance. The content of the polyethylene wax is more preferably 3.0 mass % or less and furthermore preferably 2.5 mass % or less based on the non-volatile content of paint film.

### <<Regarding Other Components>

The paint film 40 according to this embodiment may further contain a resol-type phenol resin in addition to the above components. The paint film 40 further containing the resol-type phenol resin can accelerate the paint film formation reaction at a lower temperature (for example, a temperature of a peak temperature of about 100 to 130° C.). In this event, the content of the resol-type phenol resin is preferably set to, for example, a range of 0.1 to 10.0 by mass ratio with respect to the content of the isocyanate resin. This can accelerate the paint film formation reaction at a lower temperature while suppressing a decrease in alkaline resistance of the paint film 40.

Further, the paint film 40 according to this embodiment may further contain an anticorrosive pigment, an extender pigment, a color pigment, an anti-corrosion agent, a dispersion stabilizer, and so on in addition to the above components.

### <<Regarding the Thickness>>

In the paint film 40 according to this embodiment, the thickness of the paint film 40 is in a range of 0.5 to 2.0 μm. In the case where the thickness of the paint film 40 is less than 0.5 μm, the thickness of the paint film 40 is too small, so that the surface-treated steel sheet 1 cannot exhibit sufficient corrosion resistance. By setting the thickness of the paint film 40 to 0.5 μm or more, the surface-treated steel sheet 1 can develop excellent corrosion resistance even if the surface-treated steel sheet 1 is exposed to various fuels including gasoline. The thickness of the paint film 40 is preferably 0.6 μm or more and more preferably 0.7 μm or more.

On the other hand, the case where the thickness of the paint film 40 is more than 2.0 μm is undesirable because the spot weldability and the external appearance of the surface-treated steel sheet 1 may decrease. By setting the thickness of the paint film 40 to 2.0 μm or less, it becomes possible to develop excellent corrosion resistance while suppressing the decrease in spot weldability and external appearance. The thickness of the paint film 40 is preferably 1.5 μm or less.

Here, it is possible to measure the thickness of the paint film 40 by direct observation from the cross section. Specifically, the surface-treated steel sheet to be focused on is embedded in a room-temperature drying type epoxy resin such that the cross section in the thickness direction can be observed, the embedded surface is mechanically polished, further finished to a mirror surface state, and then observed under a scanning electron microscope (SEM). The thickness is measured at a plurality of arbitrary positions (for example, ten positions), and an average value of the obtained plurality of thicknesses only needs to be regarded as the thickness of the paint film 40. In this event, the paint film 40 may be discriminated in combination with element mapping by energy dispersive X-ray spectroscopy (EDS) or an electron probe micro analyzer (EPMA).

Further, the film thickness can be converted to the thickness of the paint film 40 per unit sputtering time by measuring the depth profile from the surface side of the surface-treated steel sheet to the steel sheet side by the RF-Glow Discharge Optical Emission Spectroscopy (RF-GD-OES) and collating the sputtering time corresponding to the depth profile of a portion of the paint film 40 with the thickness of the paint film 40 by the above SEM observation from the cross section.

Note that in the depth profile obtained by the RF-Glow Discharge Optical Emission Spectroscopy, the position of the interface on the chromium-containing composite layer 30 side of the paint film 40 can also be grasped by the above-explained method. More specifically, focusing on the peak of the intensity in the range corresponding to the chromium-containing composite layer 30 in the depth profile of chromium, a position where the intensity of chromium reduces by half from the value of the peak from the position of the peak to the side of the paint film 40 can be regarded as the position of the interface between the paint film 40 and the chromium-containing composite layer 30.

Here, in the case of identifying the details of the paint film 40 from the surface-treated steel sheet in a state of having already been processed into various parts such as the fuel tank, it is only necessary to cut out a test piece from a region which has not been subjected to bonding process such as various welding or processing such as drawing or bending in a part to be focused on, and to use it as an analysis object. In this event, the size of the test piece to be cut out only needs to be, for example, about 50×50 mm in size when the test piece is made into a flat plate shape. Then, it is only necessary to execute various measurements using the obtained test piece.

For example, in the case of specifying in what contents the above components are contained in the portion of the test piece corresponding to the paint film 40, the contents can be identified based on whether or not a peak derived from the epoxy group or the isocyanate group is detected in an infrared absorption spectrum obtained by analyzing the portion corresponding to the paint film 40 by a Fourier transform infrared spectroscopy (FT-IR). If the peak derived from the epoxy group is detected in the obtained infrared absorption spectrum, it is possible to determine that the paint film 40 to be focused on contains an epoxy resin. Further, if the peak derived from the isocyanate group is detected in the obtained infrared absorption spectrum, it is possible to determine that the paint film 40 to be focused on contains an isocyanate resin.

Further, for the contents of the epoxy resin and the isocyanate resin, an epoxy resin/isocyanate resin mixed paint film whose mixture ratio of the epoxy resin and the isocyanate resin is known is produced in advance, and calibration curves of the peak intensity of the peak derived from the epoxy group and the peak intensity of the peak derived from the isocyanate group for the mixed paint film are created in advance by the FT-IR. Then, the contents of the epoxy resin and the isocyanate resin can be identified from the obtained peak intensities of the peaks in the analysis by the FT-IR obtained as above.

Further, the number average molecular weight of the epoxy resin can be identified as follows. Specifically, a sample is taken from the portion of the test piece corresponding to the paint film 40, and the molecular structure of the resin is unitized and analyzed by field desorption-mass spectroscopy (FD-MS) for the sample, whereby its molecular weight distribution can be grasped.

Besides, the presence or absence of the polyethylene wax can be identified based on whether or not the peak derived from the methylene group is detected in an infrared absorption spectrum obtained by immersing the test piece into a heated solvent (more specifically, 2-butanone heated to about 80° C.) to elute the polyethylene wax into the solvent and separate it and analyzing the obtained extract by the FT-IR. When the peak derived from the methylene group is detected in the obtained infrared absorption spectrum, the paint film 40 to be focused on can be determined to contain the polyethylene wax. Further, the content ratio of the polyethylene wax can be identified from the mass difference between before and after the extraction of the polyethylene wax.

Besides, the presence or absence of the silica particle can be identified based on whether or not the peak derived from Si—O bonding is detected in an infrared absorption spectrum obtained when confirming the presence of elements Si and O by the elemental analysis method such as a X-ray fluorescence for the portion of the test piece corresponding to the paint film 30 and then performing the analysis by the FT-IR on the portion corresponding to the paint film 30. When the presence of the elements Si and O) is confirmed by the elemental analysis method and the peak derived from the Si—O bonding is detected in the infrared absorption spectrum, the paint film 30 to be focused on can be determined to contain the silica particle.

The overall configuration of the surface-treated steel sheet 1 according to this embodiment has been explained above with reference to FIG. 1.

### <Regarding the First Composite Layer 50>

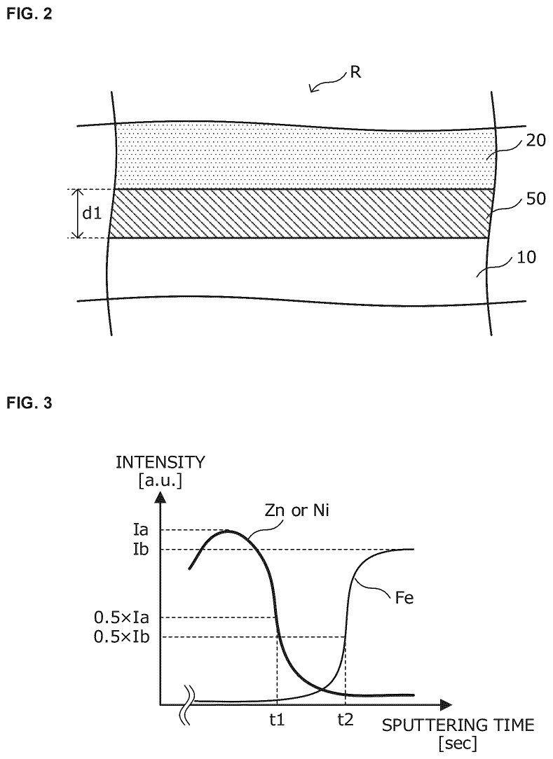

Next, a first composite layer of the surface-treated steel sheet 1 according to this embodiment will be explained in detail with reference to FIG. 2 and FIG. 3. FIG. 2 and FIG. 3 are explanatory views for explaining the first composite layer in the surface-treated steel sheet according to this embodiment.

In the surface-treated steel sheet 1 according to this embodiment, the first composite layer is located between the steel sheet 10 and the plating layer 20. Here, an enlarged schematic illustration of a layer structure of the surface-treated steel sheet 1 in a region R surrounded by a broken line (in other words, a layer structure near the interface between the steel sheet 10 and the plating layer 20) in FIG. 1 is illustrated as FIG. 2.

In FIG. 2, a layer located between the steel sheet 10 and the plating layer 20 is a first composite layer 50. The first composite layer 50 is a composite layer where iron (Fe) derived from the steel sheet 10 and Zn, Ni derived from the plating layer 20 are present. The first composite layer 50 is a layer created by Fe derived from the steel sheet 10 and Zn, Ni derived from the plating layer 20 mutually diffusing through a later-explained manufacturing method to be made composite.

The presence of the first composite layer 50 improves the adhesion between the steel sheet 10 and the plating layer 20. In cooperation with the detailed configuration of the chromium-containing composite layer 30 explained later in detail, the adhesion and the corrosion resistance of a film after molding processing can be further improved in the surface-treated steel sheet 1 according to this embodiment.

Here, an average thickness of the first composite layer 50 (thickness d1 in FIG. 2) is preferably in a range of 0.01 to 0.50 μm. By setting the average thickness d1 of the first composite layer 50 to 0.01 μm or more, it becomes possible to further improve the adhesion between the steel sheet 10 and the plating layer 20. The average thickness d1 of the first composite layer 50 is more preferably 0.03 μm or more and furthermore preferably 0.05 μm or more. On the other hand, by setting the average thickness d1 of the first composite layer 50 to 0.50 μm or less, it becomes possible to obtain sufficient moldability. The average thickness d1 of the first composite layer 50 is more preferably 0.40 μm or less and furthermore preferably 0.30 μm or less.

Here, a discrimination method of the first composite layer 50 and a measurement method of the average thickness will be explained in detail with reference to FIG. 3.

In this embodiment, regarding the discrimination method of the first composite layer 50 and the measurement method of the average thickness, depth profiles of iron, zinc, and nickel by the RF-Glow Discharge Optical Emission Spectroscopy (RF-GD-OES) from the vicinity of the interface of the plating layer 20 to the vicinity of the interface of the steel sheet 10 are focused on.

More specifically, a position where the peak of zinc or nickel that is an element derived from the plating layer 20 reduces by half in the depth profile of iron, zinc, or nickel by the RF-GD-OES from the vicinity of the interface of the plating layer 20 to the vicinity of the interface of the steel sheet 10, is defined as a position of the interface on the plating layer 20 side of the first composite layer 50. In this event, of a position specified from zinc and a position specified from nickel, a position located closer to the steel sheet 10 side is regarded as the position of the interface on the plating layer 20 side of the first composite layer 50. For example, in the example illustrated in FIG. 3, when the peak intensity of Zn or Ni on the side closer to the steel sheet 10 is Ia, a position corresponding to a sputtering time t1 at which the intensity of the element to be focused on becomes 0.5×Ia is the position of the interface on the plating layer 20 side of the first composite layer 50.

Further, in this embodiment, a position where the peak of iron that is an element derived from the steel sheet 10 reduces by half is defined as the position of the interface on the steel sheet 10 side of the first composite layer 50. For example, in the example illustrated in FIG. 3, when the peak intensity of Fe is Ib, a position corresponding to a sputtering time t2 at which the intensity of Fe becomes 0.5×Ib is the position of the interface on the steel sheet 10 of the first composite layer 50.

A range located between the two interfaces defined based on the above definition is a range of the first composite layer 50. In the example illustrated in FIG. 3, a position corresponding to the sputtering times t1 to t2 is the position of the first composite layer 50, and the thickness corresponding to the sputtering times t1 to t2 is the average thickness of the first composite layer 50. Here, from the time required for sputtering a layer whose average thickness is known, the finding regarding the thickness per unit sputtering time can be obtained, so that the sputtering time can be converted into the thickness.

Note that, in the case of identifying the first composite layer 50 from the surface-treated steel sheet in a state of having already been processed into various parts such as the fuel tank, it is only necessary to cut out a test piece from a region which has not been subjected to bonding process such as various welding or processing such as drawing or bending in a part to be focused on, and to use it as an analysis object. In this event, the size of the test piece to be cut out only needs to be, for example, about 50× 50 mm in size when the test piece is made into a flat plate shape.

### <Regarding the Detailed Structure of the Chromium-Containing Composite Layer 30>

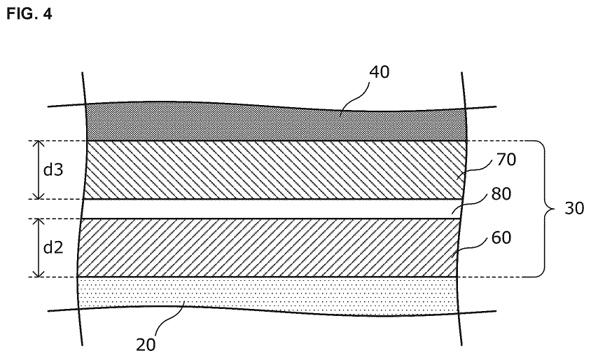

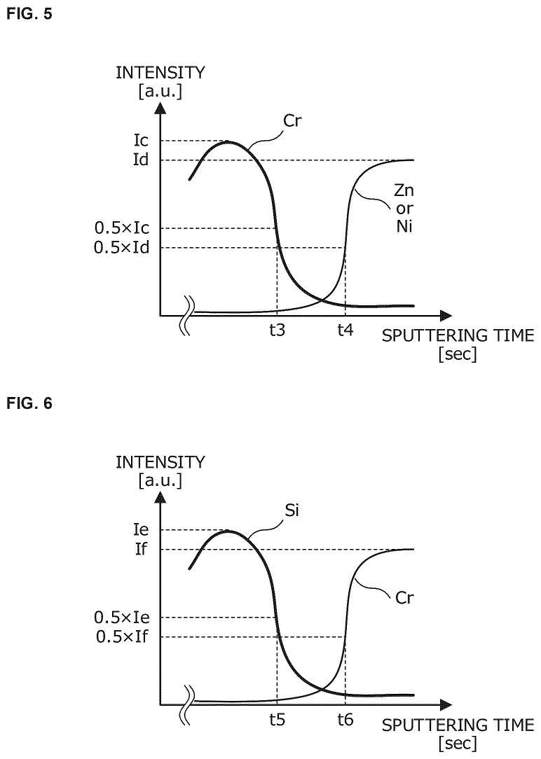

Next, a detailed structure of the chromium-containing composite layer 30 according to this embodiment will be explained with reference to FIG. 4 and FIG. 5. FIG. 4 and FIG. 5 are explanatory views for explaining the chromium-containing composite layer in the surface-treated steel sheet according to this embodiment.

The chromium-containing composite layer 30 according to this embodiment is a layer created by a part of the plating layer, a chromate film formed on the plating layer, and a part of a paint film formed on the chromate film which are made composite through a process of the manufacturing method as explained in detail in the following manufacturing method.

The chromium-containing composite layer 30 has a second composite layer 60 located on the plating layer 20 side and a third composite layer 70 located on the paint film 40 side as schematically illustrated in FIG. 4. The second composite layer 60 is a composite layer containing chromium (Cr), Zn, and Ni, and the third composite layer 70 is a composite layer containing silicon (Si), nitrogen (N), and Cr.

The second composite layer 60 is a composite layer derived from Cr present in the chromate film before being made composite and Zn and Ni present in the plating layer before being made composite, as is also inferred from that it is a composite layer containing Cr, Zn, and Ni.

Besides, the third composite layer 70 is a composite layer derived from Cr present in the chromate film before being made composite and Si of the silica particle and N of the isocyanate resin in the paint film before being made composite, as is also inferred from that it is a composite layer containing Si, N, and Cr.

Further, as schematically illustrated in FIG. 4, between the second composite layer 60 and the third composite layer 70, a layer 80 different from the two composite layers may be provided.

Conceivable examples of the layer 80 which can be present between the second composite layer 60 and the third composite layer 70 include a layer derived from the chromate film remaining without being made composite, a composite layer containing Cr, Zn, Ni, Si, N (in other words, a layer made by making the second composite layer 60 and the third composite layer 70 further composite), and so on. Besides, the chromium-containing composite layer 30 may be a layer composed of the second composite layer 60 and the third composite layer 70 without the presence of the above layer 80. Besides, the second composite layer 60 and the third composite layer 70 may be overlapped with each other.

The presence of the above second composite layer 60 and third composite layer 70 improves the adhesion between the chromium-containing composite layer 30 and the plating layer 20 and the adhesion between the chromium-containing composite layer 30 and the paint film 40. In cooperation with the above-explained first composite layer 50, the adhesion and the corrosion resistance of the film after molding processing can be further improved in the surface-treated steel sheet 1 according to this embodiment.

Here, an average thickness of the second composite layer 60 (thickness d2 in FIG. 4) is preferably in a range of 0.1 to 1.5 μm. By setting the average thickness d2 of the second composite layer 60 to 0.1 μm or more, it becomes possible to further improve the adhesion between the plating layer 20 and the chromium-containing composite layer 30. The average thickness d2 of the second composite layer 60 is more preferably 0.2 μm or more and furthermore preferably 0.5 μm or more. On the other hand, by setting the average thickness d2 of the second composite layer 60 to 1.5 μm or less, it becomes possible to appropriately disperse the stress applied to the steel sheet during molding processing. The average thickness d2 of the second composite layer 60 is more preferably 1.2 μm or less and furthermore preferably 1.0 μm or less.

Further, an average thickness of the third composite layer 70 (thickness d3 in FIG. 4) is preferably in a range of 0.1 to 1.5 μm. By setting the average thickness d3 of the third composite layer 70 to 0.1 μm or more, it becomes possible to further improve the adhesion between the chromium-containing composite layer 30 and the paint film 40. The average thickness d3 of the third composite layer 70 is more preferably 0.2 μm or more and furthermore preferably 0.5 μm or more. On the other hand, by setting the average thickness d3 of the third composite layer 70 to 1.5 μm or less, it becomes possible to appropriately disperse the stress applied to the steel sheet during molding processing. The average thickness d3 of the third composite layer 70 is more preferably 1.2 μm or less and furthermore preferably 1.0 μm or less.

Further, a ratio (d2/d1) of the average thickness d2 of the second composite layer to the average thickness di of the first composite layer is preferably 0.2 to 150.0. Besides, a ratio (d3/d1) of the average thickness d3 of the third composite layer to the average thickness d1 of the first composite layer is preferably 0.2 to 150.0.

When the ratio (d2/d1) becomes 0.2 or more, it becomes possible to further improve the adhesion between the plating layer 20 and the chromium-containing composite layer 30. The ratio (d2/d1) is more preferably 0.5 or more and furthermore preferably 1.7 or more. On the other hand, when the ratio (d2/d1) becomes 150.0 or less, it becomes possible to appropriately disperse the stress applied to the steel sheet during molding processing. The ratio (d2/d1) is more preferably 40.0 or less and furthermore preferably 20.0 or less.

When the ratio (d3/d1) becomes 0.2 or more, it becomes possible to further improve the adhesion between the chromium-containing composite layer 30 and the paint film 40. The ratio (d3/d1) is more preferably 0.5 or more and furthermore preferably 1.7 or more. On the other hand, when the ratio (d3/d1) becomes 150.0 or less, it becomes possible to appropriately disperse the stress applied to the steel sheet during molding processing. The ratio (d3/d1) is more preferably 40.0 or less and furthermore preferably 20.0 or less.

Here, a discrimination method of the second composite layer 60 and the third composite layer 70 and a measurement method of the average thicknesses d2 and d3 of the composite layers will be explained in detail with reference to FIG. 5 and FIG. 6.

In this embodiment, regarding the discrimination method of the second composite layer 60 and the measurement method of the average thickness, depth profiles of chromium, zinc, and nickel by the RF-Glow Discharge Optical Emission Spectroscopy (RF-GD-OES) from the vicinity of the interface of the paint film 40 to the vicinity of the interface of the plating layer 20 are focused on.

More specifically, a position where the peak of chromium that is an element derived from the chromium-containing composite layer 30 reduces by half in the depth profiles of chromium, zinc, and nickel by the RF-GD-OES from the vicinity of the interface of the paint film 40 to the vicinity of the interface the plating layer 20, is defined as a position of the interface on the plating layer 20 side of the second composite layer 60. For example, in the example illustrated in FIG. 5, when the peak intensity of Cr is Ic, a position corresponding to a sputtering time t3 at which the intensity of Cr becomes 0.5×Ic is the position of the interface on the plating layer 20 side of the second composite layer 60.

More specifically, in this embodiment, a position where the peak of zinc or nickel that is an element derived from the plating layer 20 reduces by half is defined as a position of the interface on the paint film 40 side of the second composite layer 60. In this event, of a position specified from zinc and a position specified from nickel, a position located closer to the paint film 40 side is regarded as the position of the interface on the paint film 40 side of the second composite layer 60. For example, in the example illustrated in FIG. 5, when the peak intensity of Zn or Ni on the side closer to the paint film 40 is Id, a position corresponding to a sputtering time t4 at which the intensity of the element to be focused on becomes 0.5×Id is the position of the interface on the paint film 40 side of the second composite layer 60.

A range located between the defined two interfaces based on the above definition is a range of the second composite layer 60. In the example illustrated in FIG. 5, a position corresponding to the sputtering times t3 to t4 is the position of the second composite layer 60, and the thickness corresponding to the sputtering times t3 to t4 is the average thickness of the second composite layer 60. Here, the findings regarding the thickness per unit sputtering time can be obtained from the time required for sputtering a layer whose thickness is known, so that the sputtering time can be converted into the thickness.

Further, in this embodiment, regarding a discrimination method of the third composite layer 70 and a measurement method of the average thickness, depth profiles of silicon and chromium by the RF-Glow Discharge Optical Emission Spectroscopy (RF-GD-OES) from the vicinity of the interface of the paint film 40 to the vicinity of the interface of the plating layer 20 are focused on.

More specifically, a position where the peak of silicon that is an element derived from the paint film 40 reduces by half in the depth profiles of silicon and chromium by the RF-GD-OES from the vicinity of the interface of the paint film 40 to the vicinity of the interface of the plating layer 20, is defined as a position of the interface on the plating layer 20 side of the third composite layer 70. For example, in the example illustrated in FIG. 6, when the peak intensity of Si is Ie, a position corresponding to a sputtering time 15 at which the intensity of Si becomes 0.5×Ie is the position of the interface on the plating layer 20 side of the third composite layer 70.

Besides, in this embodiment, a position where the peak of chromium that is an element derived from the chromium-containing composite layer 30 reduces by half is defined as a position of the interface on the paint film 40 side of the third composite layer 70. For example, in the example illustrated in FIG. 6, when the peak intensity of Cr is If, a position corresponding to a sputtering time t6 at which the intensity of Cr becomes 0.5×If is the position of the interface on the paint film 40 side of the third composite layer 70.

A range located between the defined two interfaces based on the above definition is a range of the third composite layer 70. In the example illustrated in FIG. 6, a position corresponding to the sputtering times t5 to t6 is the position of the third composite layer 70, and the thickness corresponding to the sputtering times t5 to t6 is the average thickness of the third composite layer 70. Here, the findings regarding the thickness per unit sputtering time can be obtained from the time required for sputtering a layer whose thickness is known, so that the sputtering time can be converted into the thickness.

Note that in the case of identifying the detailed structure of the chromium-containing composite layer 30 from the surface-treated steel sheet in a state of having already been processed into various parts such as the fuel tank, it is only necessary to cut out a test piece from a region which has not been subjected to bonding process such as various welding or processing such as drawing or bending in a part to be focused on, and to use it as an analysis object. In this event, the size of the test piece to be cut out only needs to be, for example, about 50×50 mm in size when the test piece is made into a flat plate shape. Then, it is only necessary to execute the above measurement using the obtained test piece.

The surface-treated steel sheet according to this embodiment has been explained above in detail with reference to FIG. 1 to FIG. 6.

### (Regarding a Method of Manufacturing the Surface-Treated Steel Sheet)

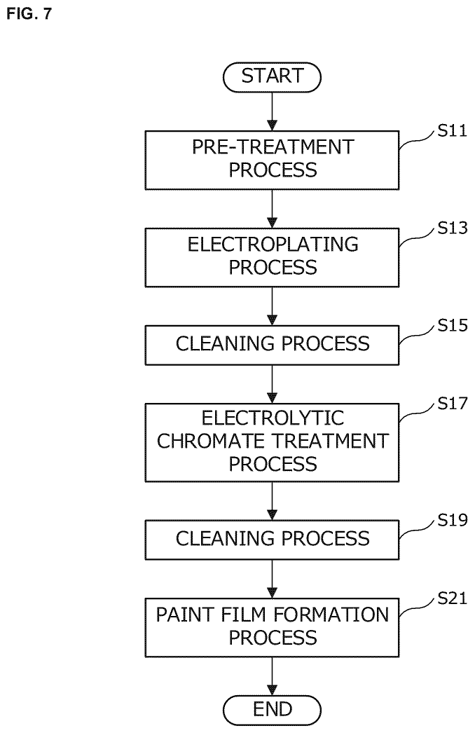

Next, a method of manufacturing the surface-treated steel sheet according to this embodiment as explained above will be explained with reference to FIG. 7. FIG. 7 is a flowchart illustrating an example of the flow of the method of manufacturing the surface-treated steel sheet according to this embodiment.

The method of manufacturing the surface-treated steel sheet according to this embodiment has a pre-treatment process (Step S11), an electroplating process (Step S13), a cleaning process (Step S15), an electrolytic chromate treatment process (Step S17), a cleaning process (Step S19), and a paint film formation process (Step S21) as illustrated in FIG. 7.

The pre-treatment process (Step S11) is a process of performing various pre-treatments including an alkaline degreasing treatment, a rinsing treatment, a pickling treatment, and the like on the steel sheet being the base metal to make a clean steel sheet surface. This pre-treatment process is not particularly specified but only needs to follow an ordinary treatment method.

The electroplating process (Step S13) is a process of forming a plating layer by an electroplating on the surface of the steel sheet being the base metal. In the electroplating process, a plating bath having components capable of realizing a desired plating composition (a plating bath containing Ni and other elements according to the need with the balance of Zn) is prepared, and electroplating is performed using the plating bath and the steel sheet with a predetermined current density and for a predetermined energization time.

Here, the bath temperature of the plating bath is preferably 50 to 70° C. Further, the current density is preferably 5 to 100 A/dm². Further, the energization time is preferably 10 to 100 seconds and more preferably 12 to 50 seconds.

As explained above, at the electroplating process (Step S13) according to this embodiment, a longer energization time is employed as compared with an ordinary zinc-nickel electroplating. This increases the immersion time of the steel sheet into the plating bath, resulting in increased diffusion of Fe in the steel sheet. Thus, regions more than usual are made composite, resulting in that the first composite layer 50 according to this embodiment is formed in an appropriate thickness.

Note that the amount of plating at the electroplating process is preferably in a range of 2 to 50 g/m² so as to realize the amount of the plating layer 20 as explained above.

The cleaning process (Step S15) is a process of performing a cleaning treatment on the steel sheet after being subjected to the electroplating process. The cleaning process is not particularly specified, but only needs to follow an ordinary treatment method.

The electrolytic chromate treatment process (Step S17) is a process of performing an electrolytic chromate treatment on the steel sheet after being subjected to the cleaning process (more specifically, the steel sheet on which the plating layer is formed).

As the electrolytic bath for the electrolytic chromate treatment, it is preferable to use the one containing Cr⁶⁺ as a main component and additionally containing sulfuric acid and halogen ions or the one containing inorganic colloids such as SiO₂ or TiO₂, metal ions such as Co or Zn in addition to the above components. The Cr ion is electrodeposited in a trivalent state using the electrolytic chromate bath to form a poorly soluble chromate film mainly containing Cr³⁺. By the formation of the poorly soluble chromate film, it becomes possible, at the conversion treatment and the electrodeposition coating which are performed afterwards on the surface-treated steel sheet, to prevent chromium elution into treatment solutions for these treatments.

Here, the bath temperature of the electrolytic chromate bath is preferably 50 to 70° C. Further, the current density is preferably 5 to 100 A/dm². Further, the energization time is preferably 1 to 10 seconds and more preferably 2 to 8 seconds.

In the method of manufacturing the surface-treated steel sheet according to this embodiment, the electrolytic chromate treatment with the above specific current density and energization time is performed as the chromate treatment. This promotes the dissolution of the components from the plating layer formed in advance to form the chromium-containing composite layer 30 according to this embodiment in cooperation with a later-explained paint film formation process.

Note that the amount of the chromate film in the electrolytic chromate treatment process is preferably in a range of 10 to 200 mg/m² in terms of metal Cr so as to realize the Cr amount as explained above.

The cleaning process (Step S19) is a process of performing a cleaning treatment on the steel sheet after being subjected to the electrolytic chromate treatment process. The cleaning process is not particularly specified, but only needs to follow an ordinary treatment method.

The paint film formation process (Step S21) is a process of performing a treatment for forming a paint film on the steel sheet after being subjected to the cleaning process (more specifically, the steel sheet on which the plating layer and the chemical treatment film are formed).

For the process, the paint for the paint film formation is prepared so as to realize the contents of the components of the paint film 40 as explained above. In the paint, the above-explained components of the paint film 40 are dissolved or dispersed in the organic solvent.

Here, in the paint film formation process according to this embodiment, a ketone-based organic solvent is preferably used as the organic solvent. The ketone-based organic solvent is contained to be 40 mass % or more of the paint mass and the paint solid concentration is adjusted to be 10 to 50 mass %, making it possible to easily form a uniform paint film.

Examples of the ketone-based organic solvent include methyl isobutyl ketone, acetonecyclohexanone, isophorone, and so on, and ketone-based organic solvents other than the above are also usable. However, it is important not to select a solvent that can react with the isocyanate resin when selecting the solvent.

The paint prepared as above is applied on the surface of the steel sheet after being subjected to the cleaning process by various methods such as a roll coating method, a curtain flow coating method, and so on. In this event, the thickness of the applied paint is preferably appropriately adjusted so that the thickness of the paint film 40 after drying falls within a range of 0.5 to 2.0 μm in consideration of the formation of the third composite layer 70.

Next, the steel sheet after the paint is applied is held, for example, in a range of a peak temperature of 100 to 200° C. for 10 to 60 seconds, whereby the solvent in the paint is vaporized and the paint solid is dried and cured to form the paint film 40. Further, in the thermal treatment process, the components contained in the paint and the components contained in the chromate film (in some cases, additionally, components contained in the first composite layer and the plating layer and so on) are thermally diffused, finally forming the chromium-containing composite layer 30 as explained above.

Through the above processes, the surface-treated steel sheet according to this embodiment as explained above is manufactured.

The method of manufacturing the surface-treated steel sheet according to this embodiment has been explained above in detail with reference to FIG. 7.

### EXAMPLES

Hereinafter, the surface-treated steel sheet according to the present invention will be concretely explained while illustrating examples and comparative examples. Note that the examples illustrated below are merely examples of the surface-treated steel sheet according to the present invention, and the surface-treated steel sheet according to the present invention is not limited to the examples illustrated below.

### (1) Zinc-Nickel Plated Steel Sheet

For the plated steel sheet, the one in which zinc-nickel plating was formed by electroplating to have a predetermined nickel content on a cold-rolled steel sheet (manufactured by NIPPON STEEL CORPORATION) was used. Note that the plating weight is a plating weight per single side. The plating layer of the zinc-nickel plated steel sheet was subjected to a spray-degreasing treatment for five seconds using a commercially available sodium orthosilicate alkaline cleaning solution, water-washed, and dried.

### (2) Chemical Treatment and Paint Treatment

A chromate chemical treatment solution and a paint were prepared.

In the chromate chemical treatment, electroplating was performed by an electrolytic chromate treatment at a solution temperature of 50 to 70° C. and with a current density in a range of 5 to 100 A/dm² for times listed in Table 1-1 to Table 1-3 below. Thereafter, each plated steel sheet was water-washed and dried.

Further, the following epoxy resin, isocyanate resin, silica particle, and polyethylene wax were used and mixed so that these components have a predetermined ratio, and used as the paint. Note that the contents listed in Table 1-1 to Table 1-3 indicate the contents in the paint films (solids).

### [Epoxy Resin]

Epoxy resin A: No. 1007 manufactured by Mitsubishi Chemical Corporation, molecular weight: 2900, epoxy equivalent: 1750-2200
Epoxy resin B: No. 827 manufactured by Mitsubishi Chemical Corporation, molecular weight: 360, epoxy equivalent: 180-190
Epoxy resin C: No. 1001 manufactured by Mitsubishi Chemical Corporation, molecular weight: 900, epoxy equivalent: 450-500
Epoxy resin D: H-360 manufactured by DIC Corporation, molecular weight: 25000
Epoxy resin E: No. 4250 manufactured by Mitsubishi Chemical Corporation, molecular weight: 60000, epoxy equivalent: 7500-8900

### [Isocyanate Resin]

Isocyanate A: hexamethylene diisocyanate manufactured by Tosoh Corporation
Isocyanate B: ethyl acetoacetate block

### [Silica Particle]

### <Fumed Silica>

Fumed silica A: Acrosil 300 manufactured by NIPPON AEROSIL CO., LTD. (average particle diameter: 7 nm)
Fumed silica B: Aerosil 200 manufactured by NIPPON AEROSIL CO.,
LTD. (average particle diameter: 12 nm)
Fumed silica C: Aerosil R972CF manufactured by NIPPON AEROSIL CO., LTD. (average particle diameter: 16 nm)
Fumed silica D: Aerosil MOX80 manufactured by NIPPON AEROSIL CO., LTD. (average particle diameter: 30 nm)
Fumed silica E: Aerosil OX50 manufactured by NIPPON AEROSIL

CO., LTD. (average particle diameter: 40 nm)

### <Colloidal Silica>

Colloidal silica A: Snowtex N manufactured by Nissan Chemical Corporation (average particle diameter: 12 nm)
Colloidal silica B: Snowtex ST-NXS manufactured by Nissan Chemical Corporation (average particle diameter: 5 nm)
Colloidal silica C: Snowtex ST-NS manufactured by Nissan Chemical Corporation (average particle diameter: 9 nm)
Colloidal silica D: Snowtex ST-N-40 manufactured by Nissan Chemical Corporation (average particle diameter: 22 nm)
Colloidal silica E: Snowtex ST-YL manufactured by Nissan Chemical Corporation (average particle diameter: 60 nm)
Colloidal silica F: Snowtex MP-2040 manufactured by Nissan Chemical Corporation (average particle diameter: 200 nm)
Colloidal silica G: Snowtex MP-454M manufactured by Nissan Chemical Corporation (average particle diameter: 450 nm)

### [Polyethylene Wax]

CERIDUST3620 manufactured by Clariant Chemicals Ltd.

The paints adjusted as above were applied by a roll coater and held in a range of a peak metal temperature (PMT) of 165 to 185° C. for 10 to 60 seconds, whereby the paints were dried and cured. The paint film thicknesses after the drying and curing are listed in Table 1-1 to Table 1-3.

For each of the surface-treated steel sheets obtained as above, the measurement of the depth profile by the RF-GD-OES was carried out for each of the elements Fe, Zn, Ni, Cr, Si, N by the above-explained method. This confirmed whether predetermined elements were contained in each composite layer. The obtained results are additionally listed in Table 1-1 to Table 1-3.

TABLE 1-1

| | | | | | | CHROMIUM-CONTAINING COMPOSITE LAYER | | |
|---|---|---|---|---|---|---|---|---|
| | FIRST COMPOSITE | | | | | | | SECOND |
| | LAYER | | Zn—Ni PLATING | | | | | COMPOSITE |
| | | AVERAGE | | PLATING | Ni | | Cr | LAYER |
| | CONTAINED | THICKNESS | TIME/ | AMOUNT/ | CONTENT/ | TIME/ | AMOUNT/ | CONTAINED |
| No. | ELEMENT | d1/μm | SECOND | gm⁻² | mass % | SECOND | mg m⁻² | ELEMENT |
| 1 | Fe, Zn, Ni | 0.01 | 6 | 20 | 10 | 0.9 | 9 | Cr, Zn, Ni |
| 2 | Fe, Zn, Ni | 0.03 | 10 | 20 | 10 | 1.6 | 20 | Cr, Zn, Ni |
| 3 | Fe, Zn, Ni | 0.12 | 12 | 20 | 10 | 1.9 | 30 | Cr, Zn, Ni |
| 4 | Fe, Zn, Ni | 0.15 | 20 | 20 | 10 | 3.1 | 30 | Cr, Zn, Ni |
| 5 | Fe, Zn, Ni | 0.16 | 30 | 20 | 10 | 4.7 | 30 | Cr, Zn, Ni |
| 6 | Fe, Zn, Ni | 0.20 | 50 | 20 | 10 | 7.8 | 30 | Cr, Zn, Ni |
| 7 | Fe, Zn, Ni | 0.90 | 100 | 20 | 10 | 9.9 | 120 | Cr, Zn, Ni |
| 8 | Fe, Zn, Ni | 1.00 | 150 | 20 | 10 | 23.4 | 210 | Cr, Zn, Ni |
| 9 | Fe, Zn, Ni | 0.13 | 20 | 20 | 10 | 3.1 | 3 | Cr, Zn, Ni |
| 10 | Fe, Zn, Ni | 0.11 | 20 | 20 | 10 | 3.1 | 10 | Cr, Zn, Ni |
| 11 | Fe, Zn, Ni | 0.13 | 20 | 20 | 10 | 3.1 | 20 | Cr, Zn, Ni |
| 12 | Fe, Zn, Ni | 0.13 | 20 | 20 | 10 | 3.1 | 30 | Cr, Zn, Ni |
| 13 | Fe, Zn, Ni | 0.12 | 20 | 20 | 10 | 3.1 | 100 | Cr, Zn, Ni |
| 14 | Fe, Zn, Ni | 0.14 | 20 | 20 | 10 | 3.1 | 150 | Cr, Zn, Ni |
| 15 | Fe, Zn, Ni | 0.14 | 20 | 20 | 10 | 3.1 | 200 | Cr, Zn, Ni |
| 16 | Fe, Zn, Ni | 0.12 | 20 | 20 | 10 | 3.1 | 250 | Cr, Zn, Ni |
| 17 | Fe, Zn, Ni | 0.11 | 20 | 20 | 10 | 3.1 | 30 | Cr, Zn, Ni |
| 18 | Fe, Zn, Ni | 0.11 | 20 | 20 | 10 | 3.1 | 30 | Cr, Zn, Ni |
| 19 | Fe, Zn, Ni | 0.11 | 20 | 20 | 10 | 3.1 | 30 | Cr, Zn, Ni |
| 20 | Fe, Zn, Ni | 0.13 | 20 | 20 | 10 | 3.1 | 30 | Cr, Zn, Ni |
| 21 | Fe, Zn, Ni | 0.11 | 20 | 20 | 10 | 3.1 | 30 | Cr, Zn, Ni |
| 22 | Fe, Zn, Ni | 0.12 | 20 | 20 | 10 | 3.1 | 30 | Cr, Zn, Ni |
| 23 | Fe, Zn, Ni | 0.10 | 20 | 20 | 10 | 3.1 | 30 | Cr, Zn, Ni |
| 24 | Fe, Zn, Ni | 0.10 | 20 | 20 | 10 | 3.1 | 30 | Cr, Zn, Ni |
| 25 | Fe, Zn, Ni | 0.20 | 30 | 20 | 10 | 4.7 | 30 | Cr, Zn, Ni |
| 26 | Fe, Zn, Ni | 0.19 | 30 | 20 | 10 | 4.7 | 30 | Cr, Zn, Ni |
| 27 | Fe, Zn, Ni | 0.16 | 30 | 20 | 10 | 4.7 | 30 | Cr, Zn, Ni |
| 28 | Fe, Zn, Ni | 0.15 | 30 | 20 | 10 | 4.7 | 30 | Cr, Zn, Ni |
| 29 | Fe, Zn, Ni | 0.19 | 30 | 20 | 10 | 4.7 | 30 | Cr, Zn, Ni |
| 30 | Fe, Zn, Ni | 0.20 | 30 | 20 | 10 | 4.7 | 30 | Cr, Zn, Ni |
| 31 | Fe, Zn, Ni | 0.17 | 30 | 20 | 10 | 4.7 | 30 | Cr, Zn, Ni |
| 32 | Fe, Zn, Ni | 0.15 | 30 | 20 | 10 | 4.7 | 30 | Cr, Zn, Ni |
| 33 | Fe, Zn, Ni | 0.25 | 40 | 20 | 10 | 6.2 | 30 | Cr, Zn, Ni |
| 34 | Fe, Zn, Ni | 0.24 | 40 | 20 | 10 | 6.2 | 30 | Cr, Zn, Ni |
| 35 | Fe, Zn, Ni | 0.24 | 40 | 20 | 10 | 6.2 | 30 | Cr, Zn, Ni |

| CHROMIUM-CONTAINING COMPOSITE LAYER | | |
|---|---|---|
| SECOND COMPOSITE LAYER | THIRD COMPOSITE LAYER | PAINT FILM |

| | | | |
|---|---|---|---|
| AVERAGE | AVERAGE | FILM | RESIN A |

| | THICKNESS | | CONTAINED | THICKNESS | | PMT/ | THICKNESS/ | | CONTENT/ |
|---|---|---|---|---|---|---|---|---|---|
| No. | d2/μm | d2/d1 | ELEMENT | d3/μm | d3/d1 | ° C. | μm | TYPE | mass % |
| 1 | 0.05 | 5.0 | Si, N, Cr | 0.05 | 5.0 | 166 | 0.8 | EPOXY A | 55.0 |
| 2 | 0.20 | 6.7 | Si, N, Cr | 0.20 | 6.7 | 172 | 0.8 | EPOXY A | 55.0 |
| 3 | 0.80 | 6.7 | Si, N, Cr | 0.80 | 6.7 | 183 | 0.8 | EPOXY A | 55.0 |
| 4 | 0.80 | 5.3 | Si, N, Cr | 0.80 | 5.3 | 171 | 0.8 | EPOXY A | 55.0 |
| 5 | 0.80 | 5.0 | Si, N, Cr | 0.80 | 5.0 | 176 | 0.8 | EPOXY A | 55.0 |
| 6 | 0.80 | 4.0 | Si, N, Cr | 0.80 | 4.0 | 178 | 0.8 | EPOXY A | 55.0 |
| 7 | 1.30 | 1.4 | Si, N, Cr | 1.40 | 1.6 | 177 | 0.8 | EPOXY A | 55.0 |
| 8 | 1.60 | 1.6 | Si, N, Cr | 1.50 | 1.5 | 166 | 0.8 | EPOXY A | 55.0 |
| 9 | 0.04 | 0.3 | Si, N, Cr | 0.04 | 0.3 | 172 | 0.8 | EPOXY A | 55.0 |
| 10 | 0.10 | 0.9 | Si, N, Cr | 0.10 | 0.9 | 174 | 0.8 | EPOXY A | 55.0 |
| 11 | 0.20 | 1.5 | Si, N, Cr | 0.20 | 1.5 | 168 | 0.8 | EPOXY A | 55.0 |
| 12 | 0.80 | 6.3 | Si, N, Cr | 0.80 | 5.3 | 175 | 0.8 | EPOXY A | 55.0 |
| 13 | 0.80 | 7.0 | Si, N, Cr | 0.80 | 7.0 | 184 | 0.8 | EPOXY A | 55.0 |
| 14 | 1.20 | 8.9 | Si, N, Cr | 1.20 | 8.9 | 171 | 0.8 | EPOXY A | 55.0 |
| 15 | 1.50 | 11.0 | Si, N, Cr | 1.50 | 11.0 | 172 | 0.8 | EPOXY A | 55.0 |
| 16 | 2.00 | 17.1 | Si, N, Cr | 2.00 | 17.1 | 173 | 0.8 | EPOXY A | 55.0 |
| 17 | 1.03 | 9.2 | Si, N, Cr | 0.69 | 6.2 | 170 | 0.4 | EPOXY A | 55.0 |
| 18 | 0.86 | 8.2 | Si, N, Cr | 0.79 | 7.4 | 177 | 0.5 | EPOXY A | 55.0 |
| 19 | 0.70 | 6.3 | Si, N, Cr | 0.59 | 5.3 | 176 | 0.6 | EPOXY A | 55.0 |
| 20 | 0.67 | 5.1 | Si, N, Cr | 0.88 | 5.6 | 174 | 0.7 | EPOXY A | 55.0 |
| 21 | 1.00 | 9.1 | Si, N, Cr | 0.82 | 7.4 | 185 | 1.2 | EPOXY A | 55.0 |
| 22 | 0.63 | 5.2 | Si, N, Cr | 0.55 | 4.5 | 168 | 1.5 | EPOXY A | 55.0 |
| 23 | 0.61 | 6.1 | Si, N, Cr | 0.83 | 8.3 | 165 | 2.0 | EPOXY A | 55.0 |
| 24 | 0.74 | 7.3 | Si, N, Cr | 0.98 | 9.7 | 165 | 5.0 | EPOXY A | 55.0 |
| 25 | 0.88 | 0.1 | Si, N, Cr | 0.52 | 3.1 | 177 | 0.8 | EPOXY A | 55.0 |
| 26 | 0.72 | 0.2 | Si, N, Cr | 0.66 | 3.5 | 176 | 0.8 | EPOXY A | 55.0 |
| 27 | 0.79 | 0.5 | Si, N, Cr | 0.73 | 4.6 | 174 | 0.8 | EPOXY A | 55.0 |
| 28 | 0.79 | 1.7 | Si, N, Cr | 0.84 | 5.6 | 165 | 0.8 | EPOXY A | 55.0 |
| 29 | 0.89 | 20.0 | Si, N, Cr | 0.77 | 4.2 | 178 | 0.8 | EPOXY A | 55.0 |
| 30 | 0.72 | 40.0 | Si, N, Cr | 0.77 | 3.9 | 174 | 0.8 | EPOXY A | 55.0 |
| 31 | 0.94 | 150.0 | Si, N, Cr | 0.86 | 5.2 | 178 | 0.8 | EPOXY A | 55.0 |
| 32 | 0.64 | 160.0 | Si, N, Cr | 0.52 | 4.1 | 175 | 0.8 | EPOXY A | 55.0 |
| 33 | 0.66 | 2.7 | Si, N, Cr | 0.73 | 0.1 | 169 | 0.8 | EPOXY A | 55.0 |
| 34 | 0.95 | 3.9 | Si, N, Cr | 0.88 | 0.2 | 185 | 0.8 | EPOXY A | 55.0 |
| 35 | 0.94 | 3.9 | Si, N, Cr | 0.84 | 0.5 | 177 | 0.8 | EPOXY A | 55.0 |

| | PAINT FILM | | | | | | |
|---|---|---|---|---|---|---|---|
| | RESIN B | | | SILICA | | POLY ETHYLENE | |
| | | CONTENT/ | EPOXY | | CONTENT/ | CONTENT/ | |
| No. | TYPE | mass % | RATIO | TYPE | mass % | mass % | REMARKS |
| 1 | ISOCYANATE A | 16.0 | 0.29 | FUMED A | 27.0 | 2.0 | COMPARATIVE EXAMPLE |
| 2 | ISOCYANATE A | 16.0 | 0.29 | FUMED A | 27.0 | 2.0 | EXAMPLE |
| 3 | ISOCYANATE A | 16.0 | 0.29 | FUMED A | 27.0 | 2.0 | EXAMPLE |
| 4 | ISOCYANATE A | 16.0 | 0.29 | FUMED A | 27.0 | 2.0 | EXAMPLE |
| 5 | ISOCYANATE A | 16.0 | 0.29 | FUMED A | 27.0 | 2.0 | EXAMPLE |
| 6 | ISOCYANATE A | 16.0 | 0.29 | FUMED A | 27.0 | 2.0 | EXAMPLE |
| 7 | ISOCYANATE A | 16.0 | 0.29 | FUMED A | 27.0 | 2.0 | EXAMPLE |
| 8 | ISOCYANATE A | 16.0 | 0.29 | FUMED A | 27.0 | 2.0 | COMPARATIVE EXAMPLE |
| 9 | ISOCYANATE A | 16.0 | 0.29 | FUMED A | 27.0 | 2.0 | COMPARATIVE EXAMPLE |
| 10 | ISOCYANATE A | 16.0 | 0.29 | FUMED A | 27.0 | 2.0 | EXAMPLE |
| 11 | ISOCYANATE A | 16.0 | 0.29 | FUMED A | 27.0 | 2.0 | EXAMPLE |
| 12 | ISOCYANATE A | 16.0 | 0.29 | FUMED A | 27.0 | 2.0 | EXAMPLE |
| 13 | ISOCYANATE A | 16.0 | 0.29 | FUMED A | 27.0 | 2.0 | EXAMPLE |
| 14 | ISOCYANATE A | 16.0 | 0.29 | FUMED A | 27.0 | 2.0 | EXAMPLE |
| 15 | ISOCYANATE A | 16.0 | 0.29 | FUMED A | 27.0 | 2.0 | EXAMPLE |
| 16 | ISOCYANATE A | 16.0 | 0.29 | FUMED A | 27.0 | 2.0 | COMPARATIVE EXAMPLE |
| 17 | ISOCYANATE A | 16.0 | 0.29 | FUMED A | 27.0 | 2.0 | COMPARATIVE EXAMPLE |
| 18 | ISOCYANATE A | 16.0 | 0.29 | FUMED A | 27.0 | 2.0 | EXAMPLE |
| 19 | ISOCYANATE A | 16.0 | 0.29 | FUMED A | 27.0 | 2.0 | EXAMPLE |
| 20 | ISOCYANATE A | 16.0 | 0.29 | FUMED A | 27.0 | 2.0 | EXAMPLE |
| 21 | ISOCYANATE A | 16.0 | 0.29 | FUMED A | 27.0 | 2.0 | EXAMPLE |
| 22 | ISOCYANATE A | 16.0 | 0.29 | FUMED A | 27.0 | 2.0 | EXAMPLE |
| 23 | ISOCYANATE A | 16.0 | 0.29 | FLMED A | 27.0 | 2.0 | EXAMPLE |
| 24 | ISOCYANATE A | 16.0 | 0.29 | FUMED A | 27.0 | 2.0 | COMPARATIVE EXAMPLE |
| 25 | ISOCYANATE A | 16.0 | 0.29 | FUMED A | 27.0 | 2.0 | EXAMPLE |
| 26 | ISOCYANATE A | 16.0 | 0.29 | FUMED A | 27.0 | 2.0 | EXAMPLE |
| 27 | ISOCYANATE A | 16.0 | 0.29 | FUMED A | 27.0 | 2.0 | EXAMPLE |
| 28 | ISOCYANATE A | 16.0 | 0.29 | FUMED A | 27.0 | 2.0 | EXAMPLE |
| 29 | ISOCYANATE A | 16.0 | 0.29 | FUMED A | 27.0 | 2.0 | EXAMPLE |
| 30 | ISOCYANATE A | 16.0 | 0.29 | FUMED A | 27.0 | 2.0 | EXAMPLE |
| 31 | ISOCYANATE A | 16.0 | 0.29 | FUMED A | 27.0 | 2.0 | EXAMPLE |
| 32 | ISOCYANATE A | 16.0 | 0.29 | FUMED A | 27.0 | 2.0 | EXAMPLE |
| 33 | ISOCYANATE A | 16.0 | 0.29 | FUMED A | 27.0 | 2.0 | EXAMPLE |
| 34 | ISOCYANATE A | 16.0 | 0.29 | FUMED A | 27.0 | 2.0 | EXAMPLE |
| 35 | ISOCYANATE A | 16.0 | 0.29 | FUMED A | 27.0 | 2.0 | EXAMPLE |

TABLE 1-2

| | | | | | | CHROMIUM-CONTAINING COMPOSITE LAYER | | |
|---|---|---|---|---|---|---|---|---|
| | FIRST COMPOSITE | | | | | | | SECOND |
| | LAYER | | Zn—Ni PLATING | | | | | COMPOSITE |
| | | AVERAGE | | PLATING | Ni | | Cr | LAYER |
| | CONTAINED | THICKNESS | TIME/ | AMOUNT/ | CONTENT/ | TIME/ | AMOUNT/ | CONTAINED |
| No. | ELEMENT | d1/μm | SECOND | gm⁻² | mass % | SECOND | mg m⁻² | ELEMENT |
| 36 | Fe, Zn, Ni | 0.22 | 40 | 20 | 10 | 6.2 | 30 | Cr, Zn, Ni |
| 37 | Fe, Zn, Ni | 0.23 | 40 | 20 | 10 | 6.2 | 30 | Cr, Zn, Ni |
| 38 | Fe, Zn, Ni | 0.23 | 40 | 20 | 10 | 6.2 | 30 | Cr, Zn, Ni |
| 39 | Fe, Zn, Ni | 0.25 | 40 | 20 | 10 | 6.2 | 30 | Cr, Zn, Ni |
| 40 | Fe, Zn, Ni | 0.22 | 40 | 20 | 10 | 6.2 | 30 | Cr, Zn, Ni |
| 41 | Fe, Zn, Ni | 0.29 | 50 | 20 | 10 | 7.8 | 30 | Cr, Zn, Ni |
| 42 | Fe, Zn, Ni | 0.27 | 50 | 20 | 10 | 7.8 | 30 | Cr, Zn, Ni |
| 43 | Fe, Zn, Ni | 0.29 | 50 | 20 | 10 | 7.8 | 30 | Cr, Zn, Ni |
| 44 | Fe, Zn, Ni | 0.27 | 50 | 20 | 10 | 7.8 | 30 | Cr, Zn, Ni |
| 45 | Fe, Zn, Ni | 0.26 | 50 | 20 | 10 | 7.8 | 30 | Cr, Zn, Ni |
| 46 | Fe, Zn, Ni | 0.09 | 12 | 20 | 10 | 1.9 | 30 | Cr, Zn, Ni |
| 47 | Fe, Zn, Ni | 0.07 | 12 | 20 | 10 | 1.9 | 30 | Cr, Zn, Ni |
| 48 | Fe, Zn, Ni | 0.07 | 12 | 20 | 10 | 1.9 | 30 | Cr, Zn, Ni |
| 49 | Fe, Zn, Ni | 0.09 | 12 | 20 | 10 | 1.9 | 30 | Cr, Zn, Ni |
| 50 | Fe, Zn, Ni | 0.08 | 12 | 20 | 10 | 1.9 | 30 | Cr, Zn, Ni |
| 51 | Fe, Zn, Ni | 0.07 | 12 | 20 | 10 | 1.9 | 30 | Cr, Zn, Ni |
| 52 | Fe, Zn, Ni | 0.11 | 12 | 20 | 10 | 1.9 | 30 | Cr, Zn, Ni |
| 53 | Fe, Zn, Ni | 0.06 | 12 | 20 | 10 | 1.0 | 30 | Cr, Zn, Ni |
| 54 | Fe, Zn, Ni | 0.12 | 20 | 20 | 10 | 3.1 | 30 | Cr, Zn, Ni |
| 55 | Fe, Zn, Ni | 0.15 | 20 | 20 | 10 | 3.1 | 30 | Cr, Zn, Ni |
| 56 | Fe, Zn, Ni | 0.15 | 20 | 20 | 10 | 3.1 | 30 | Cr, Zn, Ni |
| 57 | Fe, Zn, Ni | 0.15 | 20 | 20 | 10 | 3.1 | 30 | Cr, Zn, Ni |
| 58 | Fe, Zn, Ni | 0.13 | 20 | 20 | 10 | 3.1 | 30 | Cr, Zn, Ni |
| 59 | Fe, Zn, Ni | 0.13 | 20 | 20 | 10 | 3.1 | 30 | Cr, Zn, Ni |
| 60 | Fe, Zn, Ni | 0.10 | 20 | 20 | 10 | 3.1 | 30 | Cr, Zn, Ni |
| 61 | Fe, Zn, Ni | 0.14 | 20 | 20 | 10 | 3.1 | 30 | Cr, Zn, Ni |
| 62 | Fe, Zn, Ni | 0.15 | 30 | 20 | 10 | 4.7 | 30 | Cr, Zn, Ni |
| 63 | Fe, Zn, Ni | 0.17 | 30 | 20 | 10 | 4.7 | 30 | Cr, Zn, Ni |
| 64 | Fe, Zn, Ni | 0.20 | 30 | 20 | 10 | 4.7 | 30 | Cr, Zn, Ni |
| 65 | Fe, Zn, Ni | 0.15 | 30 | 20 | 10 | 4.7 | 30 | Cr, Zn, Ni |
| 66 | Fe, Zn, Ni | 0.16 | 30 | 20 | 10 | 4.7 | 30 | Cr, Zn, Ni |
| 67 | Fe, Zn, Ni | 0.15 | 30 | 20 | 10 | 4.7 | 30 | Cr, Zn, Ni |
| 68 | Fe, Zn, Ni | 0.18 | 30 | 20 | 10 | 4.7 | 30 | Cr, Zn, Ni |
| 69 | Fe, Zn, Ni | 0.16 | 30 | 20 | 10 | 4.7 | 30 | Cr, Zn, Ni |
| 70 | Fe, Zn, Ni | 0.23 | 40 | 20 | 10 | 6.2 | 30 | Cr, Zn, Ni |

| | CHROMIUM-CONTAINING COMPOSITE LAYER | | | | | | | |
|---|---|---|---|---|---|---|---|---|
| | SECOND COMPOSITE LAYER | | THIRD COMPOSITE LAYER | | | | | |
| | AVERAGE | | | AVERAGE | | PAINT FILM | | |
| | THICKNESS | | CONTAINED | THICKNESS | | PMT/ | FILM THICKNESS/ | RESIN A |
| No. | d2/μm | d2/d1 | ELEMENT | d3/μm | d3/d1 | ° C. | μm | TYPE |
| 36 | 0.67 | 3.0 | Si, N, Cr | 1.05 | 1.7 | 167 | 0.8 | EPOXY A |
| 37 | 0.85 | 3.7 | Si, N, Cr | 0.58 | 20.0 | 172 | 0.8 | EPOXY A |
| 38 | 0.88 | 3.9 | Si, N, Cr | 0.95 | 40.0 | 168 | 0.8 | EPOXY A |
| 39 | 0.89 | 3.6 | Si, N, Cr | 0.72 | 150.0 | 178 | 0.8 | EPOXY A |
| 40 | 0.72 | 3.2 | Si, N, Cr | 0.72 | 160.0 | 185 | 0.8 | EPOXY A |
| 41 | 1.02 | 3.5 | Si, N, Cr | 0.60 | 2.0 | 174 | 0.8 | EPOXY A |
| 42 | 0.81 | 3.0 | Si, N, Cr | 0.64 | 2.3 | 174 | 0.8 | EPOXY A |
| 43 | 0.64 | 2.2 | Si, N, Cr | 0.87 | 3.1 | 170 | 0.8 | EPOXY A |
| 44 | 0.39 | 3.3 | Si, N, Cr | 0.93 | 3.5 | 177 | 0.8 | EPOXY A |
| 45 | 0.60 | 2.3 | Si, N, Cr | 0.74 | 2.9 | 183 | 0.8 | EPOXY A |
| 46 | 0.78 | 8.2 | Si, N, Cr | 0.59 | 6.2 | 183 | 0.8 | EPOXY A |
| 47 | 0.86 | 13.2 | Si, N, Cr | 0.73 | 10.0 | 173 | 0.8 | EPOXY A |
| 48 | 0.65 | 9.6 | Si, N, Cr | 0.52 | 9.1 | 184 | 0.8 | EPOXY A |
| 49 | 0.86 | 9.1 | Si, N, Cr | 0.56 | 5.9 | 172 | 0.8 | EPOXY A |
| 50 | 0.80 | 10.2 | Si, N, Cr | 0.53 | 8.0 | 179 | 0.8 | EPOXY A |
| 51 | 0.56 | 8.7 | Si, N, Cr | 0.57 | 10.3 | 174 | 0.8 | EPOXY A |
| 52 | 0.94 | 8.6 | Si, N, Cr | 0.67 | 6.1 | 165 | 0.8 | EPOXY A |
| 53 | 0.58 | 9.2 | Si, N, Cr | 0.54 | 8.5 | 172 | 0.8 | EPOXY A |
| 54 | 0.82 | 6.6 | Si, N, Cr | 0.70 | 5.6 | 177 | 0.8 | EPOXY A |
| 55 | 0.99 | 6.8 | Si, N, Cr | 0.74 | 5.0 | 165 | 0.8 | EPOXY A |
| 56 | 0.62 | 5.6 | Si, N, Cr | 0.59 | 5.3 | 168 | 0.8 | EPOXY A |
| 57 | 0.54 | 3.7 | Si, N, Cr | 0.67 | 4.6 | 181 | 0.8 | EPOXY A |
| 58 | 0.56 | 4.4 | Si, N, Cr | 0.58 | 4.6 | 171 | 0.8 | EPOXY A |
| 59 | 0.97 | 7.4 | Si, N, Cr | 0.57 | 4.3 | 168 | 0.8 | EPOXY A |
| 60 | 0.75 | 7.2 | Si, N, Cr | 0.93 | 8.9 | 174 | 0.8 | EPOXY A |
| 61 | 0.98 | 7.1 | Si, N, Cr | 0.84 | 6.1 | 170 | 0.8 | EPOXY A |
| 62 | 0.61 | 4.0 | Si, N, Cr | 0.93 | 6.1 | 179 | 0.8 | EPOXY A |
| 63 | 0.94 | 5.4 | Si, N, Cr | 0.84 | 4.9 | 173 | 0.8 | EPOXY A |
| 64 | 1.04 | 5.3 | Si, N, Cr | 0.80 | 4.1 | 167 | 0.8 | EPOXY A |
| 65 | 0.86 | 5.7 | Si, N, Cr | 0.79 | 5.3 | 172 | 0.8 | EPOXY A |
| 66 | 0.76 | 4.3 | Si, N, Cr | 0.58 | 3.7 | 185 | 0.8 | EPOXY A |
| 67 | 0.75 | 4.9 | Si, N, Cr | 0.54 | 4.2 | 176 | 0.8 | EPOXY A |
| 68 | 0.97 | 5.3 | Si, N, Cr | 0.89 | 4.9 | 184 | 0.8 | EPOXY A |
| 69 | 0.80 | 4.9 | Si, N, Cr | 0.92 | 5.6 | 176 | 0.8 | EPOXY A |
| 70 | 1.03 | 4.4 | Si, N, Cr | 0.79 | 3.4 | 176 | 0.8 | EPOXY B |

| | PAINT FILM | | | | | | | |
|---|---|---|---|---|---|---|---|---|
| | | | | | | | POLY | |
| | RESIN A | RESIN B | | | SILICA | | ETHYLENE | |
| | CONTENT/ | | CONTENT/ | EPOXY | | CONTENT/ | CONTENT/ | |
| No. | mass % | TYPE | mass % | RATIO | TYPE | mass % | mass % | REMARKS |
| 36 | 55.0 | ISOCYANATE A | 16.0 | 0.29 | FUMED A | 27.0 | 2.0 | EXAMPLE |
| 37 | 55.0 | ISOCYANATE A | 16.0 | 0.29 | FUMED A | 27.0 | 2.0 | EXAMPLE |
| 38 | 55.0 | ISOCYANATE A | 16.0 | 0.29 | FUMED A | 27.0 | 2.0 | EXAMPLE |
| 39 | 55.0 | ISOCYANATE A | 16.0 | 0.29 | FUMED A | 27.0 | 2.0 | EXAMPLE |
| 40 | 55.0 | ISOCYANATE A | 16.0 | 0.29 | FUMED A | 27.0 | 2.0 | EXAMPLE |
| 41 | 20.0 | ISOCYANATE A | 51.0 | 2.55 | FUMED A | 27.0 | 2.0 | EXAMPLE |
| 42 | 30.0 | ISOCYANATE A | 41.0 | 1.37 | FUMED A | 27.0 | 2.0 | EXAMPLE |
| 43 | 45.0 | ISOCYANATE A | 26.0 | 0.58 | FUMED A | 27.0 | 2.0 | EXAMPLE |
| 44 | 50.0 | ISOCYANATE A | 21.0 | 0.42 | FUMED A | 27.0 | 2.0 | EXAMPLE |
| 45 | 60.0 | ISOCYANATE A | 11.0 | 0.18 | FUMED A | 27.0 | 2.0 | EXAMPLE |
| 46 | 65.0 | ISOCYANATE A | 3.3 | 0.05 | FUMED A | 29.8 | 2.0 | EXAMPLE |
| 47 | 50.0 | ISOCYANATE A | 8.0 | 0.10 | FUMED A | 32.0 | 2.0 | EXAMPLE |
| 48 | 55.0 | ISOCYANATE A | 8.3 | 0.15 | FUMED A | 34.8 | 2.0 | EXAMPLE |
| 49 | 50.0 | ISOCYANATE A | 10.0 | 0.20 | FUMED A | 38.0 | 2.0 | EXAMPLE |
| 50 | 50.0 | ISOCYANATE A | 25.0 | 0.50 | FUMED A | 23.0 | 2.0 | EXAMPLE |
| 51 | 45.0 | ISOCYANATE A | 40.5 | 0.90 | FUMED A | 12.5 | 2.0 | EXAMPLE |
| 52 | 30.0 | ISOCYANATE A | 60.0 | 2.00 | FUMED A | 8.0 | 2.0 | EXAMPLE |
| 53 | 25.0 | ISOCYANATE A | 62.5 | 2.50 | FUMED A | 10.5 | 2.0 | EXAMPLE |
| 54 | 55.0 | ISOCYANATE A | 40.0 | 0.73 | FUMED A | 3.0 | 2.0 | EXAMPLE |
| 55 | 55.0 | ISOCYANATE A | 38.0 | 0.69 | FUMED A | 5.0 | 2.0 | EXAMPLE |
| 56 | 55.0 | ISOCYANATE A | 25.0 | 0.45 | FUMED A | 18.0 | 2.0 | EXAMPLE |
| 57 | 55.0 | ISOCYANATE A | 20.0 | 0.36 | FUMED A | 23.0 | 2.0 | EXAMPLE |
| 58 | 55.0 | ISOCYANATE A | 10.0 | 0.18 | FUMED A | 33.0 | 2.0 | EXAMPLE |
| 59 | 55.0 | ISOCYANATE A | 5.0 | 0.09 | FUMED A | 38.0 | 2.0 | EXAMPLE |
| 60 | 45.0 | ISOCYANATE A | 3.0 | 0.07 | FUMED A | 50.0 | 2.0 | EXAMPLE |
| 61 | 40.0 | ISOCYANATE A | 3.0 | 0.08 | FUMED A | 55.0 | 2.0 | EXAMPLE |
| 62 | 55.0 | ISOCYANATE A | 18.0 | 0.33 | FUMED A | 27.0 | 0.0 | EXAMPLE |
| 63 | 55.0 | ISOCYANATE A | 17.9 | 0.33 | FUMED A | 27.0 | 0.1 | EXAMPLE |
| 64 | 55.0 | ISOCYANATE A | 17.0 | 0.31 | FUMED A | 27.0 | 1.0 | EXAMPLE |
| 65 | 55.0 | ISOCYANATE A | 16.5 | 0.30 | FUMED A | 27.0 | 1.5 | EXAMPLE |
| 66 | 55.0 | ISOCYANATE A | 15.5 | 0.28 | FUMED A | 27.0 | 2.5 | EXAMPLE |
| 67 | 55.0 | ISOCYANATE A | 15.0 | 0.27 | FUMED A | 27.0 | 3.0 | EXAMPLE |
| 68 | 55.0 | ISOCYANATE A | 8.0 | 0.15 | FUMED A | 27.0 | 10.0 | EXAMPLE |
| 69 | 55.0 | ISOCYANATE A | 3.0 | 0.05 | FUMED A | 27.0 | 15.0 | EXAMPLE |
| 70 | 55.0 | ISOCYANATE A | 16.0 | 0.29 | FUMED A | 27.0 | 2.0 | EXAMPLE |

TABLE 1-3

CHROMIUM-CONTAINING COMPOSITE LAYER

| | FIRST COMPOSITE | | | | | | | SECOND |
|---|---|---|---|---|---|---|---|---|
| | LAYER | | Zn—Ni PLATING | | | | | COMPOSITE |
| | | AVERAGE | | PLATING | Ni | | Cr | LAYER |
| | CONTAINED | THICKNESS/ | TIME/ | AMOUNT/ | CONTENT/ | TIME/ | AMOUNT/ | CONTAINED |
| No. | ELEMENT | d1/μm | SECOND | gm⁻² | mass % | SECOND | mg m⁻² | ELEMENT |
| 71 | Fe, Zn, Ni | 0.24 | 40 | 20 | 10 | 6.2 | 30 | Cr, Zn, Ni |
| 72 | Fe, Zn, Ni | 0.24 | 40 | 20 | 10 | 6.2 | 30 | Cr, Zn, Ni |
| 73 | Fe, Zn, Ni | 0.24 | 40 | 20 | 10 | 6.2 | 30 | Cr, Zn, Ni |
| 74 | Fe, Zn, Ni | 0.21 | 40 | 20 | 10 | 6.2 | 30 | Cr, Zn, Ni |
| 75 | Fe, Zn, Ni | 0.25 | 40 | 20 | 10 | 7.8 | 30 | Cr, Zn, Ni |
| 76 | Fe, Zn, Ni | 0.27 | 50 | 20 | 10 | 7.8 | 30 | Cr, Zn, Ni |
| 77 | Fe, Zn, Ni | 0.30 | 50 | 20 | 10 | 7.8 | 30 | Cr, Zn, Ni |
| 78 | Fe, Zn, Ni | 0.28 | 50 | 20 | 10 | 7.8 | 30 | Cr, Zn, Ni |
| 79 | Fe, Zn, Ni | 0.10 | 12 | 20 | 10 | 1.9 | 30 | Cr, Zn, Ni |
| 80 | Fe, Zn, Ni | 0.11 | 12 | 20 | 10 | 1.9 | 30 | Cr, Zn, Ni |
| 81 | Fe, Zn, Ni | 0.05 | 12 | 20 | 10 | 1.9 | 30 | Cr, Zn, Ni |
| 82 | Fe, Zn, Ni | 0.08 | 12 | 20 | 10 | 1.9 | 30 | Cr, Zn, Ni |
| 83 | Fe, Zn, Ni | 0.10 | 12 | 20 | 10 | 1.9 | 30 | Cr, Zn, Ni |
| 84 | Fe, Zn, Ni | 0.10 | 12 | 20 | 10 | 1.9 | 30 | Cr, Zn, Ni |
| 85 | Fe, Zn, Ni | 0.07 | 12 | 20 | 10 | 1.9 | 30 | Cr, Zn, Ni |
| 86 | Fe, Zn, Ni | 0.09 | 12 | 20 | 10 | 1.9 | 30 | Cr, Zn, Ni |
| 87 | Fe, Zn, Ni | 0.15 | 20 | 20 | 10 | 3.1 | 30 | Cr, Zn, Ni |
| 88 | Fe, Zn, Ni | 0.13 | 20 | 20 | 10 | 3.1 | 30 | Cr, Zn, Ni |
| 89 | Fe, Zn, Ni | 0.14 | 20 | 20 | 10 | 3.1 | 30 | Cr, Zn, Ni |
| 90 | Fe, Zn, Ni | 0.13 | 20 | 20 | 10 | 3.1 | 30 | Cr, Zn, Ni |
| 91 | Fe, Zn, Ni | 0.13 | 20 | 20 | 10 | 3.1 | 30 | Cr, Zn, Ni |
| 92 | Fe, Zn, Ni | 0.10 | 20 | 20 | 10 | 3.1 | 30 | Cr, Zn, Ni |
| 93 | Fe, Zn, Ni | 0.14 | 20 | 20 | 10 | 3.1 | 30 | Cr, Zn, Ni |
| 94 | Fe, Zn, Ni | 0.15 | 20 | 20 | 5 | 3.1 | 30 | Cr, Zn, Ni |
| 95 | Fe, Zn, Ni | 0.15 | 20 | 20 | 8 | 3.1 | 30 | Cr, Zn, Ni |
| 96 | Fe, Zn, Ni | 0.15 | 20 | 20 | 13 | 3.1 | 30 | Cr, Zn, Ni |
| 97 | Fe, Zn, Ni | 0.15 | 20 | 20 | 15 | 3.1 | 30 | Cr, Zn, Ni |
| 98 | Fe, Zn, Ni | 0.01 | 2 | 1 | 10 | 2.2 | 20 | Cr, Zn, Ni |
| 99 | Fe, Zn, Ni | 0.48 | 50 | 52 | 12 | 20.1 | 198 | Cr, Zn, Ni |
| 100 | Fe, Zn, Ni | 0.04 | 4 | 3 | 8 | 0.9 | 9 | Cr, Zn, Ni |
| 101 | Fe, Zn, Ni | 0.40 | 40 | 45 | 13 | 23.5 | 215 | Cr, Zn, Ni |
| 102 | Fe, Zn, Ni | 0.15 | 20 | 20 | 15 | 1.0 | 3 | Cr, Zn, Ni |
| 103 | Fe, Zn, Ni | 0.05 | 10 | 3 | 11 | 1.5 | 11 | Cr, Zn, Ni |
| 104 | Fe, Zn, Ni | 0.49 | 92 | 46 | 11 | 18.3 | 190 | Cr, Zn, Ni |

| | CHROMIUM-CONTAINING COMPOSITE LAYER | | | | | | | | |
|---|---|---|---|---|---|---|---|---|---|
| | SECOND COMPOSITE LAYER | | THIRD COMPOSITE LAYER | | | PAINT FILM | | | |
| | AVERAGE | | | AVERAGE | | | | RESIN A | |
| | THICKNESS | | CONTAINED | THICKNES | | PMT/ | FILM THICKNESS/ | | CONTENT |
| No. | d2/μm | d2/d1 | ELEMENT | d3/μm | d3/d1 | ° C. | μm | TYPE | mass % |
| 71 | 0.60 | 2.5 | Si, N, Cr | 0.86 | 3.5 | 165 | 0.8 | EPOXY C | 55.0 |
| 72 | 0.90 | 3.8 | Si, N, Cr | 0.63 | 2.5 | 181 | 0.8 | EPOXY D | 55.0 |
| 73 | 0.69 | 2.8 | Si, N, Cr | 1.04 | 4.3 | 180 | 0.8 | EPOXY E | 55.0 |
| 74 | 0.63 | 3.0 | Si, N, Cr | 0.61 | 2.9 | 178 | 0.8 | EPOXY A | 55.0 |
| 75 | 0.96 | 3.8 | Si, N, Cr | 0.84 | 6.3 | 179 | 0.8 | EPOXY A | 65.0 |
| 76 | 0.70 | 2.6 | Si, N, Cr | 0.68 | 2.5 | 177 | 0.8 | EPOXY A | 55.0 |
| 77 | 0.83 | 2.8 | Si, N, Cr | 0.87 | 2.9 | 165 | 0.8 | EPOXY A | 55.0 |
| 78 | 0.79 | 2.8 | Si, N, Cr | 1.05 | 3.8 | 182 | 0.8 | EPOXY A | 55.0 |
| 79 | 0.58 | 6.0 | Si, N, Cr | 0.79 | 8.1 | 180 | 0.8 | EPOXY A | 65.0 |
| 80 | 0.96 | 8.8 | Si, N, Cr | 0.98 | 8.9 | 179 | 0.8 | EPOXY A | 65.0 |
| 81 | 0.74 | 11.4 | Si, N, Cr | 0.75 | 11.7 | 174 | 0.8 | EPOXY A | 60.0 |
| 82 | 0.65 | 7.7 | Si, N, Cr | 0.92 | 11.0 | 167 | 0.8 | EPOXY A | 55.0 |
| 83 | 0.90 | 9.3 | Si, N, Cr | 0.77 | 8.0 | 167 | 0.8 | EPOXY A | 55.0 |
| 84 | 0.97 | 10.0 | Si, N, Cr | 0.99 | 10.3 | 166 | 0.8 | EPOXY A | 45.0 |
| 85 | 0.87 | 12.3 | Si, N, Cr | 0.54 | 7.6 | 176 | 0.8 | EPOXY A | 30.0 |
| 86 | 0.92 | 10.6 | Si, N, Cr | 0.87 | 10.0 | 176 | 0.8 | EPOXY A | 25.0 |
| 87 | 0.76 | 5.2 | Si, N, Cr | 0.59 | 4.1 | 180 | 0.8 | EPOXY A | 55.0 |
| 88 | 0.59 | 4.7 | Si, N, Cr | 0.96 | 7.6 | 166 | 0.8 | EPOXY A | 55.0 |
| 89 | 0.89 | 6.4 | Si, N, Cr | 0.60 | 4.3 | 179 | 0.8 | EPOXY A | 55.0 |
| 90 | 1.00 | 7.9 | Si, N, Cr | 0.99 | 7.8 | 185 | 0.8 | EPOXY A | 55.0 |
| 91 | 0.91 | 6.8 | Si, N, Cr | 0.88 | 6.5 | 182 | 0.8 | EPOXY A | 55.0 |
| 92 | 0.65 | 6.3 | Si, N, Cr | 0.90 | 8.7 | 184 | 0.8 | EPOXY A | 25.0 |
| 93 | 0.91 | 6.6 | Si, N, Cr | 1.00 | 7.2 | 182 | 0.8 | EPOXY A | 20.0 |
| 94 | 0.80 | 5.3 | Si, N, Cr | 0.80 | 5.3 | 179 | 0.8 | EPOXY A | 55.0 |
| 95 | 0.80 | 5.3 | Si, N, Cr | 0.80 | 5.3 | 185 | 0.8 | EPOXY A | 55.0 |
| 96 | 0.80 | 5.3 | Si, N, Cr | 0.80 | 5.3 | 172 | 0.8 | EPOXY A | 55.0 |
| 97 | 0.80 | 5.3 | Si, N, Cr | 0.80 | 5.3 | 184 | 0.8 | EPOXY A | 55.0 |
| 98 | 0.41 | 41.0 | Si, N, Cr | 0.80 | 30.0 | 166 | 0.7 | EPOXY A | 55.0 |
| 99 | 1.40 | 2.9 | Si, N, Cr | 1.40 | 2.9 | 185 | 1.8 | EPOXY A | 55.0 |
| 100 | 0.09 | 2.3 | Si, N, Cr | 0.09 | 2.3 | 181 | 0.7 | EPOXY A | 55.0 |
| 101 | 1.51 | 3.8 | Si, N, Cr | 1.52 | 3.8 | 180 | 1.7 | EPOXY A | 55.0 |
| 102 | 0.02 | 0.1 | Si, N, Cr | 1.10 | 7.3 | 166 | 1.5 | EPOXY A | 55.0 |
| 103 | 0.12 | 2.4 | Si, N, Cr | 1.00 | 20.0 | 170 | 1.0 | EPOXY A | 55.0 |
| 104 | 0.98 | 2.0 | Si, N, Cr | 1.10 | 2.2 | 175 | 1.1 | EPOXY A | 55.0 |

| | PAINT FILM | | | | | | |
|---|---|---|---|---|---|---|---|
| | RESIN B | | | SILICA | | POLY ETHYLENE | |
| | | CONTENT/ | EPOXY | | CONTENT/ | CONTENT/ | |
| No. | TYPE | mass % | RATIO | TYPE | mass % | mass % | REMARKS |
| 71 | ISOCYANATE A | 16.0 | 0.29 | FUMED A | 27.0 | 2.0 | EXAMPLE |
| 72 | ISOCYANATE A | 16.0 | 0.29 | FUMED A | 27.0 | 2.0 | EXAMPLE |
| 73 | ISOCYANATE A | 16.0 | 0.29 | FUMED A | 27.0 | 2.0 | EXAMPLE |
| 74 | ISOCYANATE B | 16.0 | 0.29 | FUMED A | 27.0 | 2.0 | EXAMPLE |
| 75 | ISOCYANATE A | 16.0 | 0.29 | FUMED B | 27.0 | 2.0 | EXAMPLE |
| 76 | ISOCYANATE A | 16.0 | 0.29 | FUMED C | 27.0 | 2.0 | EXAMPLE |
| 77 | ISOCYANATE A | 16.0 | 0.29 | FUMED D | 27.0 | 2.0 | EXAMPLE |
| 78 | ISOCYANATE A | 16.0 | 0.29 | FUMED E | 27.0 | 2.0 | EXAMPLE |
| 79 | ISOCYANATE A | 30.0 | 0.46 | COLLOIDAL A | 3.0 | 2.0 | EXAMPLE |
| 80 | ISOCYANATE A | 28.0 | 0.43 | COLLOIDAL A | 5.0 | 2.0 | EXAMPLE |
| 81 | ISOCYANATE A | 20.0 | 0.33 | COLLOIDAL A | 18.0 | 2.0 | EXAMPLE |
| 82 | ISOCYANATE A | 20.0 | 0.36 | COLLOIDAL A | 23.0 | 2.0 | EXAMPLE |
| 83 | ISOCYANATE A | 13.0 | 0.24 | COLLOIDAL A | 30.0 | 2.0 | EXAMPLE |
| 84 | ISOCYANATE A | 15.0 | 0.33 | COLLOIDAL A | 38.0 | 2.0 | EXAMPLE |
| 85 | ISOCYANATE A | 18.0 | 0.60 | COLLOIDAL A | 50.0 | 2.0 | EXAMPLE |
| 86 | ISOCYANATE A | 18.0 | 0.72 | COLLOIDAL A | 55.0 | 2.0 | EXAMPLE |
| 87 | ISOCYANATE A | 16.0 | 0.29 | COLLOIDAL B | 27.0 | 2.0 | EXAMPLE |
| 88 | ISOCYANATE A | 16.0 | 0.29 | COLLOIDAL C | 27.0 | 2.0 | EXAMPLE |
| 89 | ISOCYANATE A | 16.0 | 0.29 | COLLOIDAL D | 27.0 | 2.0 | EXAMPLE |
| 90 | ISOCYANATE A | 16.0 | 0.29 | COLLOIDAL E | 27.0 | 2.0 | EXAMPLE |
| 91 | ISOCYANATE A | 16.0 | 0.29 | COLLOIDAL F | 27.0 | 2.0 | EXAMPLE |
| 92 | ISOCYANATE A | 23.0 | 0.92 | COLLOIDAL G | 50.0 | 2.0 | EXAMPLE |
| 93 | ISOCYANATE A | 75.0 | 0.05 | FUMED A | 3.0 | 2.0 | EXAMPLE |
| 94 | ISOCYANATE A | 15.0 | 0.29 | FUMED A | 27.0 | 2.0 | EXAMPLE |
| 95 | ISOCYANATE A | 16.0 | 0.29 | FUMED A | 27.0 | 2.0 | EXAMPLE |
| 96 | ISOCYANATE A | 16.0 | 0.29 | FUMED A | 27.0 | 2.0 | EXAMPLE |
| 97 | ISOCYANATE A | 16.0 | 0.29 | FUMED A | 27.0 | 2.0 | EXAMPLE |
| 98 | ISOCYANATE A | 16.0 | 0.29 | FUMED A | 27.0 | 2.0 | COMPARATIVE EXAMPLE |
| 99 | ISOCYANATE A | 16.0 | 0.29 | FUMED A | 27.0 | 2.0 | COMPARATIVE EXAMPLE |
| 100 | ISOCYANATE A | 16.0 | 0.29 | FUMED A | 27.0 | 2.0 | COMPARATIVE EXAMPLE |
| 101 | ISOCYANATE A | 16.0 | 0.29 | FUMED A | 27.0 | 2.0 | COMPARATIVE EXAMPLE |
| 102 | ISOCYANATE A | 16.0 | 0.29 | FUMED A | 27.0 | 2.0 | COMPARATIVE EXAMPLE |
| 103 | ISOCYANATE A | 16.0 | 0.29 | FUMED A | 27.0 | 2.0 | EXAMPLE |
| 104 | ISOCYANATE A | 16.0 | 0.29 | FUMED A | 27.0 | 2.0 | EXAMPLE |

Further, for the obtained surface-treated steel sheets, evaluations of the adhesion of drawn part, the corrosion resistance of drawn part, the corrosion resistance of flat surface, and the corrosion resistance after degreasing were performed. The evaluation methods and evaluation criteria for the evaluations are as follows. The obtained results are collectively listed in Table 2-1 to Table 2-3 below.

<Adhesion after Drawing >

A test piece was cut out from each surface-treated steel sheet and subjected to cylindrical cup drawing by drawing under the conditions of a punch diameter: 50 mmφ, a punch shoulder R: 5 mm, a blank diameter: 100 mmφ, a drawing ratio: 2.0, and a pressing pressure: 1 t. A molded product obtained by the above cylindrical cup drawing was subjected to cross-cutting at a body portion of the cylindrical cup, then immersed in boiling water for one hour, and subjected to post-adhesion evaluation. Note that the cross-cutting was performed at two facing positions of positions (positions at 45° from an L-direction and a C-direction) located at the middle in a rolling direction (L-direction) of the steel sheet and an orthogonal direction (C-direction) at a body portion of a drawn cylindrical cup. The cross-cutting was performed such that a position at a height of 5 mm from a drawing end surface of the body portion is regarded as a starting point and one cut has a length of 40 mm toward a bottom surface direction of the cylindrical cup and two cuts are orthogonal at 90°. At the cross-cutting at the two positions performed at the body portion after the cylindrical drawing, a peeling width of the paint film from the cut portion was measured and the largest one was scored. An evaluation point of 2 or higher was determined to be acceptable.

### [Evaluation Criteria]

Evaluation point 5:0.1 mm or less
4: more than 0.1 mm and 0.2 mm or less
3: more than 0.2 mm and 0.3 mm or less
2: more than 0.3 mm and 0.4 mm or less
1: more than 0.4 mm
   <Corrosion Resistance after Drawing >

A test piece was cut out from each surface-treated steel sheet and subjected to ball head projection up to a height of 7 mm by Erichsen tester and then to a salt spray test (JIS Z 2371:2015) for 500 hours, and evaluated by an occurrence area ratio of white rust at a ball head projection portion. The test piece was subjected to the evaluation with its end surface and rear surface portion sealed. An evaluation point of 2 or higher was determined to be acceptable.

### [Evaluation Criteria]

Evaluation point 5: 5% or less
4: more than 5% and 7% or less
3: more than 7% and 10% or less
2: more than 10% and 12% or less
1: more than 12%

### <Corrosion Resistance of Flat Surface >

A test piece was cut out from each surface-treated steel sheet and subjected to a salt spray test (JIS Z 2371:2015) for 500 hours, and evaluated by an occurrence area ratio of white rust. The test piece was subjected to the evaluation with its end surface and rear surface portion sealed. An evaluation point of 2 or higher was determined to be acceptable.

### [Evaluation Criteria]

Evaluation point 5: 1% or less
4: more than 1% and 3% or less
3: more than 3% and 5% or less
2: more than 5% and 10% or less
1: more than 10%
   <Corrosion Resistance after Degreasing >

A test piece was cut out from each surface-treated steel sheet and subjected to spray degreasing for two minutes at 60° C. using a commercially available sodium orthosilicate alkaline cleaning solution, then subjected to a salt spray test (JIS Z 2371:2015) for 500 hours, and evaluated by an occurrence area ratio of white rust at a flat surface portion. The test piece was subjected to the evaluation with its end surface and rear surface portion sealed. An evaluation point of 2 or higher was determined to be acceptable.

### [Evaluation Criteria]

Evaluation point 5: 5% or less
4: more than 5% and 7% or less
3: more than 7% and 10% or less
2: more than 10% and 12% or less
1: more than 12%

TABLE 2-1

| | EVALUATION | | | | |
|---|---|---|---|---|---|
| | | CORROSION | | CORROSION | |
| | ADHESION | RESISTANCE | FLAT SURFACE | RESISTANCE | |
| | AFTER | AFTER | CORROSION | AFTER | |
| No. | DRAWING | DRAWING | RESISTANCE | DEGREASING | REMARKS |
| 1 | 1 | 1 | 1 | 1 | COMPARATIVE EXAMPLE |
| 2 | 5 | 4 | 5 | 5 | EXAMPLE |
| 3 | 5 | 5 | 5 | 5 | EXAMPLE |
| 4 | 5 | 5 | 5 | 5 | EXAMPLE |
| 5 | 5 | 5 | 5 | 5 | EXAMPLE |
| 6 | 5 | 5 | 5 | 5 | EXAMPLE |
| 7 | 4 | 4 | 5 | 5 | EXAMPLE |
| 8 | 1 | 1 | 1 | 1 | COMPARATIVE EXAMPLE |
| 9 | 1 | 1 | 1 | 1 | COMPARATIVE EXAMPLE |
| 10 | 4 | 4 | 4 | 4 | EXAMPLE |
| 11 | 4 | 4 | 5 | 5 | EXAMPLE |
| 12 | 5 | 5 | 5 | 5 | EXAMPLE |
| 13 | 5 | 5 | 5 | 5 | EXAMPLE |
| 14 | 4 | 5 | 5 | 5 | EXAMPLE |
| 15 | 3 | 5 | 5 | 5 | EXAMPLE |
| 16 | 1 | 1 | 1 | 1 | COMPARATIVE EXAMPLE |
| 17 | 1 | 1 | 1 | 1 | COMPARATIVE EXAMPLE |
| 18 | 4 | 3 | 4 | 4 | EXAMPLE |
| 19 | 5 | 3 | 5 | 3 | EXAMPLE |
| 20 | 5 | 5 | 5 | 5 | EXAMPLE |
| 21 | 4 | 5 | 5 | 5 | EXAMPLE |
| 22 | 3 | 5 | 5 | 5 | EXAMPLE |
| 23 | 5 | 5 | 5 | 5 | EXAMPLE |
| 24 | 1 | 1 | 1 | 1 | COMPARATIVE EXAMPLE |
| 25 | 2 | 2 | 2 | 2 | EXAMPLE |
| 26 | 3 | 5 | 5 | 5 | EXAMPLE |
| 27 | 4 | 5 | 5 | 5 | EXAMPLE |
| 28 | 5 | 5 | 5 | 5 | EXAMPLE |
| 29 | 5 | 5 | 5 | 5 | EXAMPLE |
| 30 | 4 | 5 | 5 | 5 | EXAMPLE |
| 31 | 3 | 5 | 5 | 5 | EXAMPLE |
| 32 | 2 | 2 | 2 | 2 | EXAMPLE |
| 33 | 2 | 2 | 2 | 2 | EXAMPLE |
| 34 | 3 | 5 | 5 | 5 | EXAMPLE |
| 35 | 4 | 5 | 5 | 5 | EXAMPLE |

TABLE 2-2

| | EVALUATION | | | | |
|---|---|---|---|---|---|
| | | CORROSION | | CORROSION | |
| | ADHESION | RESISTANCE | FLAT SURFACE | RESISTANCE | |
| | AFTER | AFTER | CORROSION | AFTER | |
| No. | DRAWING | DRAWING | RESISTANCE | DEGREASING | REMARKS |
| 36 | 5 | 5 | 5 | 5 | EXAMPLE |
| 37 | 5 | 5 | 5 | 5 | EXAMPLE |
| 38 | 4 | 5 | 5 | 5 | EXAMPLE |
| 39 | 3 | 5 | 5 | 5 | EXAMPLE |
| 40 | 2 | 2 | 2 | 2 | EXAMPLE |
| 41 | 2 | 2 | 3 | 3 | EXAMPLE |
| 42 | 3 | 3 | 4 | 3 | EXAMPLE |
| 43 | 3 | 3 | 4 | 3 | EXAMPLE |
| 44 | 5 | 5 | 5 | 5 | EXAMPLE |
| 45 | 3 | 3 | 4 | 4 | EXAMPLE |
| 46 | 2 | 2 | 3 | 3 | EXAMPLE |
| 47 | 3 | 3 | 4 | 3 | EXAMPLE |
| 48 | 3 | 3 | 4 | 4 | EXAMPLE |
| 49 | 3 | 3 | 4 | 4 | EXAMPLE |
| 50 | 5 | 5 | 5 | 5 | EXAMPLE |
| 51 | 3 | 3 | 4 | 3 | EXAMPLE |
| 52 | 3 | 3 | 4 | 3 | EXAMPLE |
| 53 | 2 | 2 | 3 | 3 | EXAMPLE |
| 54 | 3 | 2 | 3 | 3 | EXAMPLE |
| 55 | 3 | 3 | 4 | 3 | EXAMPLE |
| 56 | 3 | 3 | 4 | 4 | EXAMPLE |
| 57 | 5 | 5 | 5 | 5 | EXAMPLE |
| 58 | 3 | 3 | 4 | 4 | EXAMPLE |
| 59 | 3 | 3 | 3 | 3 | EXAMPLE |
| 60 | 3 | 3 | 3 | 3 | EXAMPLE |
| 61 | 2 | 2 | 3 | 3 | EXAMPLE |
| 62 | 2 | 2 | 3 | 3 | EXAMPLE |
| 63 | 5 | 5 | 5 | 5 | EXAMPLE |
| 64 | 5 | 5 | 5 | 5 | EXAMPLE |
| 65 | 5 | 5 | 5 | 5 | EXAMPLE |
| 66 | 5 | 5 | 5 | 5 | EXAMPLE |
| 67 | 5 | 5 | 5 | 5 | EXAMPLE |
| 68 | 5 | 5 | 5 | 5 | EXAMPLE |
| 69 | 2 | 2 | 3 | 3 | EXAMPLE |
| 70 | 4 | 3 | 4 | 4 | EXAMPLE |

TABLE 2-3

| | EVALUATION | | | | |
|---|---|---|---|---|---|
| | | CORROSION | | CORROSION | |
| | ADHESION | RESISTANCE | FLAT SURFACE | RESISTANCE | |
| | AFTER | AFTER | CORROSION | AFTER | |
| No. | DRAWING | DRAWING | RESISTANCE | DEGREASING | REMARKS |
| 71 | 4 | 4 | 4 | 4 | EXAMPLE |
| 72 | 4 | 4 | 4 | 4 | EXAMPLE |
| 73 | 4 | 3 | 4 | 4 | EXAMPLE |
| 74 | 5 | 5 | 5 | 5 | EXAMPLE |
| 75 | 5 | 5 | 5 | 5 | EXAMPLE |
| 76 | 5 | 5 | 5 | 5 | EXAMPLE |
| 77 | 5 | 4 | 5 | 4 | EXAMPLE |
| 78 | 5 | 4 | 5 | 4 | EXAMPLE |
| 79 | 2 | 2 | 3 | 3 | EXAMPLE |
| 80 | 3 | 3 | 4 | 3 | EXAMPLE |
| 81 | 3 | 3 | 4 | 4 | EXAMPLE |
| 82 | 5 | 5 | 5 | 5 | EXAMPLE |
| 83 | 5 | 5 | 5 | 5 | EXAMPLE |
| 84 | 3 | 3 | 4 | 4 | EXAMPLE |
| 85 | 3 | 3 | 4 | 3 | EXAMPLE |
| 86 | 2 | 2 | 3 | 3 | EXAMPLE |
| 87 | 4 | 4 | 5 | 4 | EXAMPLE |
| 88 | 4 | 5 | 5 | 4 | EXAMPLE |
| 89 | 5 | 5 | 5 | 5 | EXAMPLE |
| 90 | 4 | 5 | 5 | 4 | EXAMPLE |
| 91 | 4 | 4 | 5 | 4 | EXAMPLE |
| 92 | 2 | 2 | 3 | 2 | EXAMPLE |
| 93 | 3 | 3 | 3 | 3 | EXAMPLE |
| 94 | 5 | 5 | 5 | 5 | EXAMPLE |
| 95 | 5 | 5 | 5 | 5 | EXAMPLE |
| 96 | 5 | 5 | 5 | 5 | EXAMPLE |
| 97 | 5 | 5 | 5 | 5 | EXAMPLE |
| 98 | 1 | 1 | 1 | 1 | COMPARATIVE EXAMPLE |
| 99 | 1 | 3 | 5 | 5 | COMPARATIVE EXAMPLE |
| 100 | 2 | 1 | 1 | 1 | COMPARATIVE EXAMPLE |
| 101 | 1 | 3 | 5 | 5 | COMPARATIVE EXAMPLE |
| 102 | 2 | 1 | 1 | 1 | COMPARATIVE EXAMPLE |
| 103 | 2 | 2 | 2 | 2 | EXAMPLE |
| 104 | 3 | 3 | 5 | 5 | EXAMPLE |

As is clear from Table 2-1 to Table 2-3 above, the surface-treated steel sheets corresponding to the examples of the present invention showed acceptable results regarding the adhesion of drawn part, the corrosion resistance of drawn part, the corrosion resistance of flat surface, and the corrosion resistance after degreasing, whereas the surface-treated steel sheets corresponding to the comparative examples of the present invention showed unacceptable results regarding at least any of the adhesion of drawn part, the corrosion resistance of drawn part, the corrosion resistance of flat surface, and the corrosion resistance after degreasing.

For example, in the comparative examples in Nos. 1 and 8, the Cr amounts in the chromium-containing composite layers were out of the range of the present invention due to the energization times in the electrolytic chromate treatment, so that the adhesion of drawn part, the corrosion resistance of drawn part, the corrosion resistance of flat surface, and the corrosion resistance after degreasing were unacceptable. Besides, in the comparative examples in Nos. 9 and 16, the Cr amounts in the chromium-containing composite layers were out of the range of the present invention due to the chromium concentrations in the electrolytic baths used, so that the adhesion of drawn part, the corrosion resistance of drawn part, the corrosion resistance of flat surface, and the corrosion resistance after degreasing were unacceptable. Besides, in the comparative examples in Nos. 17 and 24, the film thicknesses of the paint films were out of the range of the present invention because the conditions of the roll coater when applying the paints were not appropriate, so that the adhesion of drawn part, the corrosion resistance of drawn part, the corrosion resistance of flat surface, and the corrosion resistance after degreasing were unacceptable.

In the comparative example in No. 98, the plating weight of the Zn—Ni plating layer was out of the range of the present invention, so that the adhesion of drawn part, the corrosion resistance of drawn part, the corrosion resistance of flat surface, and the corrosion resistance after degreasing were unacceptable. Besides, in the comparative example in No. 99, the plating weight of the Zn—Ni plating layer was out of the range of the present invention, so that the adhesion of drawn part was unacceptable.

In the comparative example in No. 100, the Cr amount in the chromium-containing composite layer was out of the range of the present invention due to the chromium concentration in the electrolytic bath used, so that the corrosion resistance of drawn part, the corrosion resistance of flat surface, and the corrosion resistance after degreasing were unacceptable. Besides, in the comparative example in No. 101, the Cr amount in the chromium-containing composite layer was out of the range of the present invention due to the chromium concentration in the electrolytic bath used, so that the adhesion of drawn part was unacceptable. Besides, in the comparative example in No. 102, the Cr amount in the chromium-containing composite layer was out of the range of the present invention because the bath temperature of the electrolytic bath used was set to 40° C., so that the corrosion resistance of drawn part, the corrosion resistance of flat surface, and the corrosion resistance after degreasing were unacceptable.

Preferred embodiments of the present invention have been explained above in detail with reference to the attached drawings, but the present invention is not limited to the embodiments. It should be understood that various changes and modifications are readily apparent to those skilled in the art who have the common general knowledge in the technical field to which the present invention pertains, within the scope of the technical spirit as set forth in claims, and they should also be covered by the technical scope of the present invention.

The embodiments disclosed herein are examples in all respects and should not be considered to be restrictive. Various omissions, substitutions, and changes may be made in the embodiments without departing from the scope of the attached claims, and the configuration and the spirit belonging to the technical field of the present invention as will be described. For example, configuration requirements of the above embodiments can be arbitrarily combined as long as the effects thereof are not impaired. From an arbitrary combination, the operations and effects about the configuration requirements relating to the combination can be naturally obtained, and other operations and other effects apparent to those skilled in the art are obtained from the description herein.

Besides, the effects explained herein are merely explanatory or illustrative in all respects and not restrictive. In other words, the technique relating to the present invention can offer other effects apparent to those skilled in the art from the description herein in addition to or in place of the above effects.

Note that the following configurations also belong to the technical scope of the present invention.
(1) A surface-treated steel sheet including:
   a plating layer located on at least one surface of a steel sheet and containing zinc and nickel;
   a first composite layer located between the steel sheet and the plating layer and containing Fe, Zn, and Ni;
   a chromium-containing composite layer located on the plating layer and containing at least Cr; and
   a paint film located on the chromium-containing composite layer and containing an epoxy resin, an isocyanate resin, and a silica particle, wherein:
   an amount of the plating layer is 2 to 50 g/m² per single side;
   the chromium-containing composite layer includes
      a second composite layer located on the plating layer side and containing Cr, Zn, and Ni, and
      a third composite layer located on the paint film side and containing Si, N, and Cr;
   an amount of the chromium-containing composite layer is 10 to 200 mg/m² in terms of metal Cr; and
   a thickness of the paint film is 0.5 to 2.0 μm.
(2) The surface-treated steel sheet according to (1), wherein:
   a ratio (d2/d1) of an average thickness d2 of the second composite layer to an average thickness d1 of the first composite layer is 0.2 to 150.0; and
   a ratio (d3/d1) of an average thickness d3 of the third composite layer to the average thickness d1 of the first composite layer is 0.2 to 150.0.
(3) The surface-treated steel sheet according to (1) or (2), wherein:
   the paint film contains a polyethylene wax at a ratio of 0.1 to 10.0 mass % based on a non-volatile content of paint film;
   a content of the epoxy resin is 30.0 mass % or more based on the non-volatile content of paint film
   a content of the isocyanate resin is 0.10 to 2.00 by mass ratio with respect to the epoxy resin;
   a content of the silica particle is 5.0 to 50.0 mass % based on the non-volatile content of paint film; and
   the paint film contains the epoxy resin, the isocyanate resin, the silica particle, and the polyethylene wax in a total of 100 mass % or less.
(4) The surface-treated steel sheet according to any one of (1) to (3), wherein
   the epoxy resin is a bisphenol A-type epoxy resin having a number average molecular weight of 300 to 100000.
(5) The surface-treated steel sheet according to any one of (1) to (4), wherein:
   the silica particle is at least any of fumed silica and colloidal silica;
   an average particle diameter of the fumed silica is 5 to 40 nm; and
   an average particle diameter of the colloidal silica is 5 to 200 nm.
(6) The surface-treated steel sheet according to any one of (1) to (5), which is used as a raw material for a fuel tank.

### EXPLANATION OF CODES

1 surface-treated steel sheet
10 steel sheet
20 plating layer
30 chromium-containing composite layer
40 paint film
50 first composite layer
60 second composite layer
70 third composite layer

1. A surface-treated steel sheet comprising:
a plating layer located on at least one surface of a steel sheet and containing zinc and nickel;
a first composite layer located between the steel sheet and the plating layer and containing Fe, Zn, and Ni;
a chromium-containing composite layer located on the plating layer and containing at least Cr; and
a paint film located on the chromium-containing composite layer and containing an epoxy resin, an isocyanate resin, and a silica particle, wherein:
an amount of the plating layer is 2 to 50 g/m² per single side;
the chromium-containing composite layer includes
a second composite layer located on the plating layer side and containing Cr, Zn, and Ni, and
a third composite layer located on the paint film side and containing Si, N, and Cr;
an amount of the chromium-containing composite layer is 10 to 200 mg/m² in terms of metal Cr; and
a thickness of the paint film is 0.5 to 2.0 μm.

2. The surface-treated steel sheet according to claim 1, wherein:
a ratio (d2/d1) of an average thickness d2 of the second composite layer to an average thickness d1 of the first composite layer is 0.2 to 150.0; and
a ratio (d3/d1) of an average thickness d3 of the third composite layer to the average thickness d1 of the first composite layer is 0.2 to 150.0.

3. The surface-treated steel sheet according to claim 1, wherein:
the paint film contains a polyethylene wax at a ratio of 0.1 to 10.0 mass % based on a non-volatile content of paint film;
a content of the epoxy resin is 30.0 mass % or more based on the non-volatile content of paint film;
a content of the isocyanate resin is 0.10 to 2.00 by mass ratio with respect to the epoxy resin;
a content of the silica particle is 5.0 to 50.0 mass % based on the non-volatile content of paint film; and
the paint film contains the epoxy resin, the isocyanate resin, the silica particle, and the polyethylene wax in a total of 100 mass % or less.

4. The surface-treated steel sheet according to claim 1, wherein the epoxy resin is a bisphenol A-type epoxy resin having a number average molecular weight of 300 to 100000.

5. The surface-treated steel sheet according to claim 1, wherein:
the silica particle is at least any of fumed silica and colloidal silica;
an average particle diameter of the fumed silica is 5 to 40 nm; and
an average particle diameter of the colloidal silica is 5 to 200 nm.

6. The surface-treated steel sheet according to claim 1, which is used as a raw material for a fuel tank.
